(19) United States
(12) Patent Application Publication
(10) Pub. No.: US 2017/0103429 A1
(43) Pub. Date: Apr. 13, 2017

(54) INTELLIGENT AD AUCTION AND SLA COMPLIANCE TECHNIQUES

(71) Applicant: Pubmatic, Inc., Redwood City, CA (US)

(72) Inventors: Kartik SURA, Pune (IN); Rohan BANKAR, Pune (IN); Suraj G. NARKHEDE, Pune (IN); Anand DAS, Sunnyvale, CA (US); Kartik MAHAJAN, Punjab (US)

(21) Appl. No.: 15/385,466

(22) Filed: Dec. 20, 2016

Related U.S. Application Data
(63) Continuation of application No. 14/276,548, filed on May 13, 2014.

(51) Int. Cl. G06Q 30/02

(52) U.S. Cl. CPC G06Q 30/0275; G06Q 30/0267; G06Q 30/0264; G06Q 30/0277

(57) ABSTRACT

Various types of Intelligent Ad Auction and Response Latency Timeout compliance techniques are described which may be implemented at Advertising Service Provider Systems and ad servers for intelligently handling ad requests in online and mobile electronic data networks.

This application claims the priority benefit of the following: This application is Continuation of patent application Ser. No. 14/276,548 filed May 13, 2014.

### BACKGROUND

The present disclosure relates to online advertising techniques and, more particularly, relates to techniques for implementing Intelligent Ad Auction and Response Latency Timeout compliance techniques in online and mobile environments.

A significant quantity of content published on the Internet is supported by advertisements (“ads”). Publishers of Internet-based content often make use of a robust infrastructure of ad networks and/or exchanges that handles the selection, placement, and insertion of ads in web pages. These ad networks and/or exchanges generally select from a set of available ads, based on various factors such as geographic location, subject matter, and the like, in an effort to present ads that are most likely to be maximize revenue in a given context. Advertisers pay the ad networks and/or exchanges for ad exposures based on, among other factors, expected or actual performance of the ad determined, for example, by counting the number of times users click on the ad. Accordingly, revenue can be increased by placing ads to maximize response and effectiveness.

As the online advertising industry continues to grow, the amount of control that publishers (entities who have an inventory of advertising space to sell) want with respect to selling this ad space inventory also grows. As a result, there is an increasing desire among publishers to carve out specific inventory buckets for their ad space inventory. On the advertiser side, advertisers are now increasingly particular about how much they will pay to place their ads on Web pages.

Various mechanisms for measuring performance and effectiveness of advertisements are available. One well-known measurement of ad performance is effective cost per mille (e-CPM), which indicates a cost (or price) of showing an ad one thousand times. e-CPM is therefore a measurement of revenue that a publisher can expect to receive from an ad network based on the number of impressions, or page views, of the content. e-CPM is often determined on an estimated basis. Revenue for an Internet publisher is maximized when an advertisement having high e-CPM is shown. Higher e-CPM means that an ad network is willing to pay more because of an expectation that an ad will be more effective.

In many situations, Internet publishers use several different ad networks and/or exchanges for their online advertising needs. Existing techniques for selecting advertisements often fail to perform effective comparisons among multiple ad networks and/or exchanges. Without comparisons among multiple ad networks, existing techniques fail to provide Internet publishers with sufficient information to most effectively monetize their inventory.

In addition, existing techniques often fail to provide Internet publishers with sufficiently detailed information concerning the effects of various factors that can affect the money that they earn. Such factors include, for example, user frequency, geography, context/vertical, rate of ads that are defaulting to another network, demographic data, and the like.

Without a systematic approach to optimize ad network and/or exchange selection, including selection among multiple ad networks and/or exchanges and effective handling of defaults, publishers can lose a significant amount of advertising revenue.

### BRIEF DESCRIPTION OF THE DRAWINGS

FIG. 1 illustrates a simplified block diagram of a specific example embodiment of an Advertising Network 100.

FIG. 2 is a block diagram showing an example embodiment of entities and interactions for implementing various aspects of the online advertising techniques disclosed herein.

FIG. 3A is a block diagram depicting an overall architecture for implementing various aspects of the online advertising techniques disclosed herein.

FIG. 3B is a block diagram illustrating data flow for an embodiment for implementing various aspects of the online advertising techniques disclosed herein.

FIGS. 4-8B show different example scenarios illustrating how the Intelligent Ad Auction Procedure may go about handling the filling of a publisher ad request under different types of circumstances and conditions.

FIG. 9 shows a flow diagram of an Intelligent Ad Auction Procedure in accordance with a specific embodiment.

FIG. 10 shows a flow diagram of a Response Latency Timeout Compliance Procedure in accordance with a specific embodiment.

FIG. 11 illustrates an example embodiment of an ad server system which may be used for implementing various aspects/features described herein.

### DETAILED DESCRIPTION OF EXAMPLE EMBODIMENTS

### Overview

Various types of Intelligent Ad Auction and Response Latency Timeout compliance techniques are described which may be implemented at Advertising Service Provider Systems and ad servers for intelligently handling ad requests in online and mobile electronic data networks.

One or more disclosed herein are directed to various SLA compliance and fulfillment techniques which may be implemented at Advertising Service Provider Systems and ad servers for intelligently handling ad requests in a manner which helps to ensure that a given Publisher's ad request is timely filled and the ad served within the specified SLA Response Timeout period.

One aspect disclosed herein is directed to different methods, systems, and computer program products for facilitating servicing of ad requests over an electronic data network. In at least one embodiment, various method(s), system(s) and/or computer program product(s) may be operable to cause at least one processor to execute a plurality of instructions for: receiving, at a first ad server, a first ad request from a remote device, the first ad request including information relating to a first ad impression to be displayed in connection with a display of a first web page at an end user's device, the first web page being associated with a first publisher; determining a first Response Latency Timeout value (Trlt) to be used for servicing the first ad request, wherein the first Response Latency Timeout value represents a total maximum amount of time which is permitted to elapse until a response to the first ad request is received at the remote device; dynamically determining a Treceive value representing a first amount of time taken for the first ad request from the remote device to reach the ad server; determining a Tsend value representing a second amount of time it takes for an ad request response from the ad server to reach the remote device; dynamically determining, in real-time, an amount of remaining time which is currently available for the ad server to monetize the first ad impression and provide a response to the first ad request which is received at the remote device within an amount of time that does not exceed the Response Latency Timeout value; selectively identifying a first set of activities to be performed by the ad server to monetize the first ad impression in the amount of time remaining and provide the response to the first ad request which is received at the remote device within the amount of time that does not exceed the Response Latency Timeout value; performing the identified first set of activities at the ad server for monetizing the first ad impression; and providing the response to the first ad request to the remote device such that the response is received at the remote device within the amount of time that does not exceed the Response Latency Timeout value.

In at least one embodiment, various method(s), system(s) and/or computer program product(s) may be further operable to cause at least one processor to execute additional instructions for: identifying at least one action to be implemented at the ad server to facilitate the ad server in monetizing the first ad impression and in enabling the ad server to provide the response to the first ad request which is received at the remote device within an amount of time that does not exceed the Response Latency Timeout value; initiating, at the ad server, the identified at least one action; and/or wherein the identified at least one action includes at least one action selected from a group consisting of: (a) omitting performance of a real-time bid (RTB) auction in connection with the first ad request; (b) reducing a timeout parameter associated with RTB ad solicitation request calls to thereby reduce an amount of time spent in waiting for responses to the RTB ad solicitation request calls to be received at the ad server during servicing of the first ad request; (c) omitting performance of one or more ad solicitation request calls to one or more mobile advertising networks during servicing of the first ad request; (d) reducing a timeout parameter associated with mobile advertising network ad solicitation request calls to thereby reduce an amount of time spent in waiting for responses to the mobile advertising network ad solicitation request calls to be received at the ad server during servicing of the first ad request; and/or (e) reducing a Call Threshold value to thereby reduce a number of mobile advertising network ad solicitation request calls or hops to be performed by the ad server in servicing the first ad request;

In at least one embodiment, various method(s), system(s) and/or computer program product(s) may be further operable to cause at least one processor to execute additional instructions for: dynamically determining a remaining time value (Trem) representing a maximum total amount of remaining time available for the ad server to service the first ad request, wherein a calculation of the Trem value includes subtracting from the Trlt value the Treceive value and the Tsend value; and/or selectively identifying, using the Trem value, the first set of activities to be performed by the ad server to monetize the first ad impression;

In at least one embodiment, various method(s), system(s) and/or computer program product(s) may be further operable to cause at least one processor to execute additional instructions for: determining if there is sufficient time available for the ad server to solicit real-time bid (RTB) response(s) from a first set of advertising network(s) in connection with the first ad request and to provide a response to the first ad request which is received at the remote device within an amount of time that does not exceed the Response Latency Timeout value; if it is determined that there is sufficient time available for the ad server to solicit real-time bid (RTB) response(s) from the first set of advertising network(s) in connection with the first ad request, performing the real-time bid (RTB) auction in connection with servicing the first ad request; and/or if it is determined that there is insufficient time available for the ad server to solicit real-time bid (RTB) response(s) from the first set of advertising network(s) in connection with the first ad request, omitting performance of the real-time bid (RTB) auction in connection with servicing ad request.

In at least one embodiment, various method(s), system(s) and/or computer program product(s) may be further operable to cause at least one processor to execute additional instructions for: determining if there is sufficient time available for the ad server to perform a first hop of mobile advertising network call(s) in connection with the first ad request and to provide a response to the first ad request which is received at the remote device within an amount of time that does not exceed the Response Latency Timeout value; if it is determined that there is sufficient time available for the ad server to perform the first hop of mobile advertising network call(s) in connection with the first ad request, performing the first hop of mobile advertising network call(s) in connection with servicing the first ad request; and/or if it is determined that there is insufficient time available for the ad server to perform the first hop of mobile advertising network call(s) in connection with the first ad request, omitting performance of the first hop of mobile advertising network call(s) in connection with servicing ad request.

In at least one embodiment, various method(s), system(s) and/or computer program product(s) may be further operable to cause at least one processor to execute additional instructions for: dynamically determining a remaining time value (Trem) representing a maximum total amount of remaining time available for the ad server to service the first ad request, wherein a calculation of the Trem value includes subtracting from the Trlt value the Treceive value and the Tsend value; and/or determining an RTB timeout parameter (Trtb) representing a timeout value associated with RTB ad solicitation request calls performed in connection with servicing the first ad request; determining an Adnet/S2S timeout parameter (Tadnet) representing a timeout value associated with mobile advertising network ad solicitation request calls performed in connection with servicing the first ad request; comparing relative values of Trem, Trtb, and Tadnet; if it is determined that Trem≧Trtb and that Trem≧Tadnet, performing, in parallel: (i) a real-time bid (RTB) auction in connection with the first ad request, and (ii) and a first hop of mobile advertising network call(s) in connection with servicing the first ad request; if it is determined that Trem≧Trtb and that Trem<Tadnet, performing a real-time bid (RTB) auction in connection with the first ad request, and omitting performance of mobile advertising network ad solicitation request calls in connection with servicing the first ad request; and/or if it is determined that Trem<Trtb and the Trem<Tadnet, performing, in parallel: (i) a real-time bid (RTB) auction in connection with the first ad request the RTB Network calls, omitting performance of the real-time bid (RTB) auction in connection with the first ad request, and omitting performance of mobile advertising network ad solicitation request calls in connection with servicing the first ad request.

In at least one embodiment, various method(s), system(s) and/or computer program product(s) may be further operable to cause at least one processor to execute additional instructions for: soliciting real-time bid (RTB) response(s) from a first set of advertising network(s) in connection with the first ad request; thereafter, dynamically determining, in real-time, an updated remaining time value (Tup) representing an amount of remaining time which is currently available for the ad server to service the first ad request and provide a response to the first ad request which is received at the remote device within an amount of time that does not exceed the Response Latency Timeout value; dynamically determining, using the Tup time value, if there is sufficient time available for the ad server to perform a hop of mobile advertising network call(s) to a first set of mobile network advertisers in connection with the first ad request and provide a response to the first ad request which is received at the remote device within an amount of time that does not exceed the Response Latency Timeout value; if it is determined that there is sufficient time available for the ad server to perform the first hop of mobile advertising network call(s), performing the first hop of mobile advertising network call(s) to the first set of mobile network advertisers in connection with servicing the first ad request; and/or if it is determined that there is insufficient time available for the ad server to perform the first hop of mobile advertising network call(s) in connection with the first ad request, omitting performance of the first hop of mobile advertising network call(s) in connection with servicing ad request.

In at least one embodiment, various method(s), system(s) and/or computer program product(s) may be further operable to cause at least one processor to execute additional instructions for: performing a first hop of mobile advertising network call(s) to a first set of mobile network advertisers in connection with the first ad request; thereafter, dynamically determining, in real-time, an updated remaining time value (Tup) representing an amount of remaining time which is currently available for the ad server to service the first ad request and provide a response to the first ad request which is received at the remote device within an amount of time that does not exceed the Response Latency Timeout value; dynamically determining, using the Tup time value, if there is sufficient time available for the ad server to perform a second hop of mobile advertising network call(s) to a second set of mobile network advertisers in connection with the first ad request and provide a response to the first ad request which is received at the remote device within an amount of time that does not exceed the Response Latency Timeout value; if it is determined, using the Tup time value, that there is sufficient time available for the ad server to perform the second hop of mobile advertising network call(s), performing the second hop of mobile advertising network call(s) to the second set of mobile network advertisers in connection with servicing the first ad request; and/or if it is determined, using the Tup time value, that there is insufficient time available for the ad server to perform the second hop of mobile advertising network call(s) in connection with the first ad request, omitting performance of the second hop of mobile advertising network call(s) in connection with servicing ad request.

In at least one embodiment, various method(s), system(s) and/or computer program product(s) may be further operable to cause at least one processor to execute additional instructions for: soliciting real-time bid (RTB) response(s) from a first set of advertising network(s) in connection with the first ad request; thereafter, dynamically determining, in real-time, an updated remaining time value (Tup) representing an amount of remaining time which is currently available for the ad server to service the first ad request and provide a response to the first ad request which is received at the remote device within an amount of time that does not exceed the Response Latency Timeout value; selectively identifying, using the Tup time value, a second set of activities to be performed by the ad server in connection with servicing the first ad request in the amount of time remaining and provide the response to the first ad request which is received at the remote device within the amount of time that does not exceed the Response Latency Timeout value; and/or performing the identified second set of activities at the ad server in connection with servicing the first ad request.

In at least one embodiment, various method(s), system(s) and/or computer program product(s) may be further operable to cause at least one processor to execute additional instructions for: performing a first hop of mobile advertising network call(s) to a first set of mobile network advertisers in connection with the first ad request; thereafter, dynamically determining, in real-time, an updated remaining time value (Tup) representing an amount of remaining time which is currently available for the ad server to service the first ad request and provide a response to the first ad request which is received at the remote device within an amount of time that does not exceed the Response Latency Timeout value; selectively identifying, using the Tup time value, a second set of activities to be performed by the ad server in connection with servicing the first ad request in the amount of time remaining and provide the response to the first ad request which is received at the remote device within the amount of time that does not exceed the Response Latency Timeout value; and/or performing the identified second set of activities at the ad server in connection with servicing the first ad request.

Various objects, features and advantages of the various aspects described or referenced herein will become apparent from the following descriptions of its example embodiments, which descriptions should be taken in conjunction with the accompanying drawings.

### Specific Example Embodiments

Various techniques will now be described in detail with reference to a few example embodiments thereof as illustrated in the accompanying drawings. In the following description, numerous specific details are set forth in order to provide a thorough understanding of one or more aspects and/or features described or reference herein. It will be apparent, however, to one skilled in the art, that one or more aspects and/or features described or reference herein may be practiced without some or all of these specific details. In other instances, well known process steps and/or structures have not been described in detail in order to not obscure some of the aspects and/or features described or reference herein.

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

Techniques and mechanisms described or reference herein will sometimes be described in singular form for clarity. However, it should be noted that particular embodiments include multiple iterations of a technique or multiple instantiations of a mechanism unless noted otherwise.

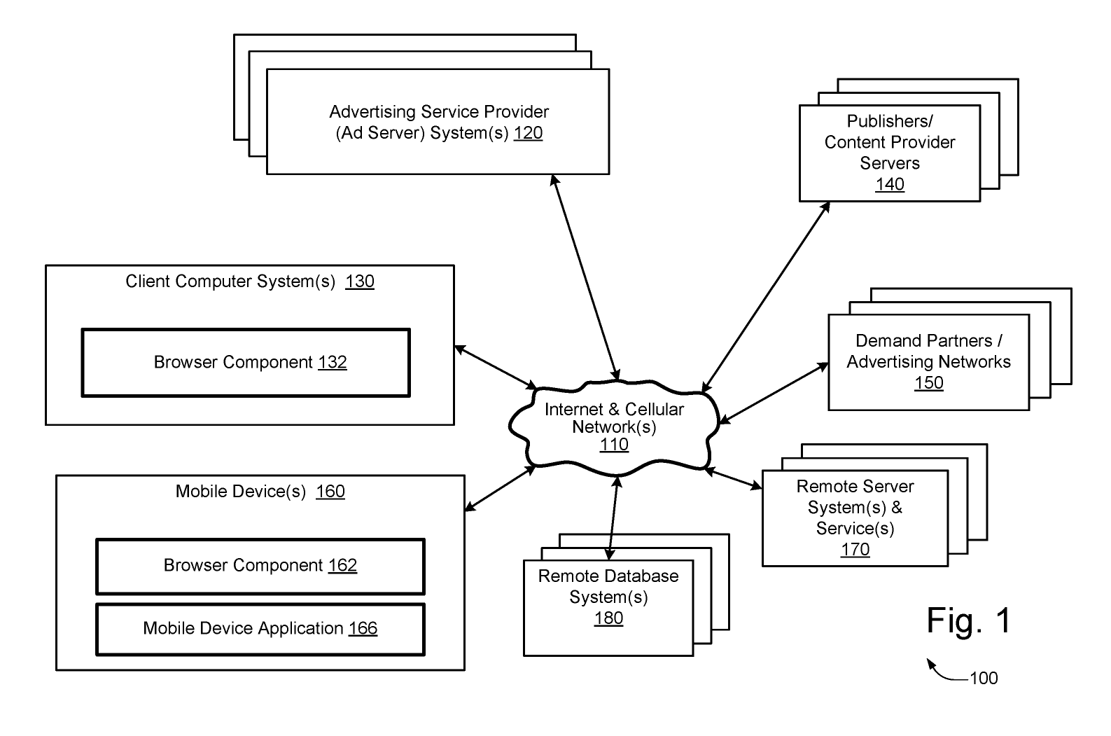

FIG. 1 illustrates a simplified block diagram of a specific example embodiment of an Advertising Network 100. As described in greater detail herein, different embodiments of Advertising Networks may be configured, designed, and/or operable to provide various different types of operations, functionalities, and/or features generally relating to advertising technology.

According to different embodiments, at least some Advertising Network(s) and Advertising System(s) disclosed herein may be configured, designed, and/or operable to provide a number of different advantages and/or benefits and/or may be operable to initiate, and/or enable various different types of operations, functionalities, and/or features, such as, for example, one or more of those described and/or referenced herein.

According to different embodiments, at least a portion of the various functions, actions, operations, and activities performed by one or more component(s) of the Advertising Network may be initiated in response to detection of one or more conditions, events, and/or other criteria satisfying one or more different types of minimum threshold criteria, such as, for example, one or more of those described and/or referenced herein. Further, according to different embodiments, at least a portion of the various types of functions, operations, actions, and/or other features provided by the various system(s) and component(s) of the Advertising Network may be implemented at one or more client systems(s), at one or more server systems (s), and/or combinations thereof.

According to different embodiments, the Advertising Network 100 may include a plurality of different types of components, devices, modules, processes, systems, etc., which, for example, may be implemented and/or instantiated via the use of hardware and/or combinations of hardware and software. For example, as illustrated in the example embodiment of FIG. 1, the Advertising Network may include one or more of the following types of systems, components, devices, processes, etc. (or combinations thereof):
Advertising Service Provider (Ad Server) System(s) 120, which, for example, may be operable to perform and/or implement various types of ad server functions, operations, actions, and/or other features such as those described or referenced herein.
Publisher/Content Provider Servers(s) 140, which, for example, may be configured or designed to render and provide access to various internet-based web sites, web pages, etc.
Client Computer System (s) 130.
Demand Partners/Advertising Networks 150, which, for example, may be operable to serve or supply ads, such as demand side partners (DSP), ATDs, RTB networks, mobile advertising networks (e.g., Adnet, S2S), ad campaign networks, trading desks and advertisers, such as Ford, Proctor & Gamble, and Coca-Cola.
Internet & Cellular Network(s) 110.
Remote Database System(s) 180.
Remote Server System(s) & Service(s) 170, which, for example, may include, but are not limited to, one or more of the following (or combinations thereof):
   Content provider servers/services
   Media Streaming servers/services
   Database storage/access/query servers/services
   Financial transaction servers/services
   Payment gateway servers/services
   Electronic commerce servers/services
   Event management/scheduling servers/services
   Etc.
Mobile Device(s) 160.
etc.

As illustrated in the example embodiment of FIG. 1, the Client Computer System(s) 130 and/or Mobile Device(s) 160 may each include browser component(s) (e.g., 132, 162). As used herein, the term “browser component”, “web browser” and/or the act of “browsing” may be defined to include any type of application, hardware, and/or combination of hardware/software implemented at a computing device which facilitates or enables the computing device to access information and/or resources from local and/or wide area networks such as, for example, the Internet and/or World Wide Web. Examples of such computing devices may include PDAs, smart phones, notebook computers, tablets, netbooks, desktop computing systems, server systems, cloud computing systems, network devices, personal computers, mobile devices, Smart TVs, wearable technology (such as intelligent glasses, watches, etc.) and/or other computing devices which include web browser functionality for accessing Internet-based websites and web pages.

According to different embodiments, the Advertising Service Provider System 120 may include one or more ad servers which may communicate directly and/or indirectly with other entities of the Advertising Network(s). One goal of Publisher(s)/Content Provider(s) 140 is to obtain the highest CPM price (i.e., cost per thousand ad impressions) for each of its advertising segments. One goal of the Demand Partners/Advertising Networks 150 is to serve online ads that reach as narrow and targeted an audience as possible (e.g., serve ads that are most effective). As illustrated in the example embodiment of FIG. 1, there is communication between Publisher(s)/Content Provider(s) 140 and Advertising Service Provider System 120 and communication between Advertising Service Provider System 120 and Demand Partners/Advertising Networks 150.

In at least one embodiment, Demand Partners/Advertising Networks 150 may include, for example, one or more of the following (or combinations thereof):
Advertisers and/or ad serving entities who participate in real-time bidding or auctioning of ad impressions.
API-based ad serving networks such as “Adnet” or Server-to-Server (“S2S”). In some embodiments, different API-based ad serving networks may be classified as either Beacon Based Counting (BBC) Networks or Server Side Counting Networks (Non BBC). Typically, a Server Side Counting Network only counts an impression (e.g., for CPM purposes) when the network responds with a valid creative. This may also be referred to as Server based counting (e.g., an impression is counted once the creative is returned). Alternatively, a Beacon Based Counting Network counts an impression when the creative is rendered (e.g., via use of a beacon). For example, in Beacon based Counting (BBC), an impression is counted by the network once the ad serving beacon is executed)

Generally, if the advertiser/ad serving entity is assured that their ad will be seen by the right audience, the advertiser/ad serving entity would be willing to pay more for placing the ad. One role of Advertising Service Provider System 120 is to facilitate reaching both these goals by acting as an ad serving broker between the two entities (e.g., Publisher(s)/Content Provider(s) 140 and Demand Partners/Advertising Networks 150).

Some publisher(s) and/or content provider(s) may desire to exercise more control in determining minimum (floor) e-CPM prices for their online advertising spots. Additionally, some publisher(s) and/or content provider(s) may desire to create, carve out, and/or allocate specific ad space inventory buckets. For example, an online publisher or content provider may have 100 ad spots that it wants to fill. A certain number of the spots, for example 40, are on web pages that are most likely viewed by viewers who earn above $80,000 annual income, live in metropolitan areas in the U.S., and may be either male or female. Another 35 spots are likely to be viewed by people between the ages of 18-35 who are interested in sports. Another 23 spots are likely viewed by people ages 55-70, male or female, and interested in travel, and so on. Of course, many more categories can be used to describe these buckets and they can be much more specific. Some publisher(s) and/or content provider(s) may desire to set a floor e-CPM for each bucket. The floor e-CPM for ad segments associated with the first bucket described in the above example (e.g., male or female viewers who earn above $80,000 annual income, live in metropolitan areas in the U.S.) may be higher than the floor e-CPM for ad spots associated with the second bucket (e.g., viewed by the 18-35 year old sports enthusiasts). The Publisher(s)/Content Provider(s) may be provided with the ability to exercise fine grained control over the pricing of their respective ad spots. For example, an online publisher or content provider may set floor e-CPMs which are more economically feasible for advertisers and/or may set floor e-CPMs which advertisers are more willing to pay.

From the advertiser/ad serving entity perspective, giving the Publisher(s)/Content Provider(s) more control over ad serving is also more appealing. An advertiser/ad serving entity such as Nike would be more willing to pay a higher floor e-CPM for placing an ad that is more likely to be viewed by people interested in sports and are of a certain age range. Similarly, a luxury brand advertiser/ad serving entity is also more likely to pay a higher e-CPM for placing an ad on a page that is more likely to be viewed by male or female viewers having a high annual salary, are between certain ages, and live in metropolitan areas where the luxury brand has stores. There is a wide variety of such advertiser/ad serving entities catering to audiences or markets having a specific demographic or socio-economic background, and having other characteristics. Accordingly, publisher(s) and/or content provider(s) may desire to create different tiers or types of advertising buckets, each with its own respective floor e-CPM that can cater to each of these groups.

However, because it may not be practical or desirable for Publisher(s)/Content Provider(s) to communicate directly with Advertiser/Ad Serving Entities to obtain the highest e-CPM floor price that the market is willing to pay, advertising service providers (such as, for example, Advertising Service Provider System 120) may be employed to facilitate communication between the Publisher(s)/Content Provider(s), web page viewer (e.g., client/mobile system end user), and the Advertiser(s)/AD Serving Entities. Some of the more larger and well-known Publishers/Content Providers may also set floor e-CPMs for specific advertiser/ad serving entities who are associated with specific Agency Trading Desks (ATDs) and/or Demand-Side Platforms (DSPs) that would like to advertise to certain users which match specific demography and geography characteristics. For example, if a user is female, between the ages of 25-35 and lives in London, the Publisher(s)/Content Provider(s) will ask for a lower e-CPM if the advertiser/ad serving entity is Nike and is through DSP1 and an even lower e-CPM if it is Nike through DSP2.

As is well known in the industry, an ad is served after a user has downloaded a Web page into the web browser of the end user's computer or mobile device. The code comprising the Web page (most often HTML) is executed by the browser and the ads are served to the end user's computing device from the ad source. In at least one embodiment, the entity serving the ad may be the Advertising Service Provider System 120 which receives it from one or more Demand Partners/Advertising Networks 150. When the viewer goes to a web site or web page, and the HTML for the site is executed in the end user's browser, the end user's user identifier information is available to the publisher/content provider. In at least one embodiment, the user identifier information may be defined to include information which may be used to uniquely identify a specific user or a collection of users. A variety of different methods and/or techniques may be used to identify, acquire and/or store the user identifier information in one or more user identifier information files. An example of one type of user identifier information file is a cookie (also known as an HTTP cookie, web cookie, or browser cookie). The user identifier information file (herein, “UII File”) is interpreted by the code in the publisher/content provider's web page and then an HTTP call is made to the Advertising Service Provider System with certain UII File parameters. Certain information in the UII File is used by the publisher/content provider and the Advertising Service Provider System to enable serving the most appropriate ad for the ad segments on the web page(s) being loaded on the end user's computing device. In one embodiment, this information may include a user ID (UID) and a system ID (SID), as well as other information described and/or referenced herein.

In at least one embodiment, the Advertising Service Provider System may be operable to utilize and/or generate various different types of data and/or other types of information when performing specific tasks and/or operations. This may include, for example, input data/information and/or output data/information. For example, in at least one embodiment, the Advertising Service Provider System may be operable to access, process, and/or otherwise utilize information from one or more different types of sources, such as, for example, one or more local and/or remote memories, devices and/or systems. Additionally, in at least one embodiment, the Advertising Service Provider System may be operable to generate one or more different types of output data/information, which, for example, may be stored in memory of one or more local and/or remote devices and/or systems. Examples of different types of input data/information and/or output data/information which may be accessed and/or utilized by the Advertising Service Provider System may include, but are not limited to, one or more of those described and/or referenced herein.

According to specific embodiments, multiple instances or threads of the Advertising Service Provider System may be concurrently implemented and/or initiated via the use of one or more processors and/or other combinations of hardware and/or hardware and software. For example, in at least some embodiments, various aspects, features, and/or functionalities of the Advertising Service Provider System may be performed, implemented and/or initiated by one or more of the various systems, components, systems, devices, procedures, processes, etc., described and/or referenced herein.

In at least one embodiment, one or more Advertising Service Provider Systems may access and/or utilize information from one or more associated databases. In at least one embodiment, at least a portion of the database information may be accessed via communication with one or more local and/or remote memory devices. Examples of different types of data which may be accessed by the Advertising Service Provider System may include, but are not limited to, one or more of those described and/or referenced herein.

According to different embodiments, various different types of encryption/decryption techniques may be used to facilitate secure communications between devices in Advertising Service Provider System(s) and/or Advertising Service Provider System(s). Examples of the various types of security techniques which may be used may include, but are not limited to, one or more of the following (or combinations thereof): random number generators, SHA-1 (Secured Hashing Algorithm), MD2, MD5, DES (Digital Encryption Standard), 3DES (Triple DES), RC4 (Rivest Cipher), ARC4 (related to RC4), TKIP (Temporal Key Integrity Protocol, uses RC4), AES (Advanced Encryption Standard), RSA, DSA, DH, NTRU, and ECC (elliptic curve cryptography), PKA (Private Key Authentication), Device-Unique Secret Key and other cryptographic key data, SSL, etc. Other security features contemplated may include use of well-known hardware-based and/or software-based security components, and/or any other known or yet to be devised security and/or hardware and encryption/decryption processes implemented in hardware and/or software.

It will be appreciated that the Advertising Network of FIG. 1 is but one example from a wide range of Advertising Network embodiments which may be implemented. Other embodiments of the Advertising Network (not shown) may include additional, fewer and/or different components/features that those illustrated in the example Advertising Network embodiment of FIG. 1.

Generally, the advertising techniques described herein may be implemented in hardware and/or hardware+software. For example, they can be implemented in an operating system kernel, in a separate user process, in a library package bound into network applications, on a specially constructed machine, or on a network interface card. In a specific embodiment, various aspects described herein may be implemented in software such as an operating system or in an application running on an operating system.

Hardware and/or software+hardware hybrid embodiments of the advertising techniques described herein may be implemented on a general-purpose programmable machine selectively activated or reconfigured by a computer program stored in memory. Such programmable machine may include, for example, mobile or handheld computing systems, PDA, smart phones, notebook computers, tablets, netbooks, desktop computing systems, server systems, cloud computing systems, network devices, etc.

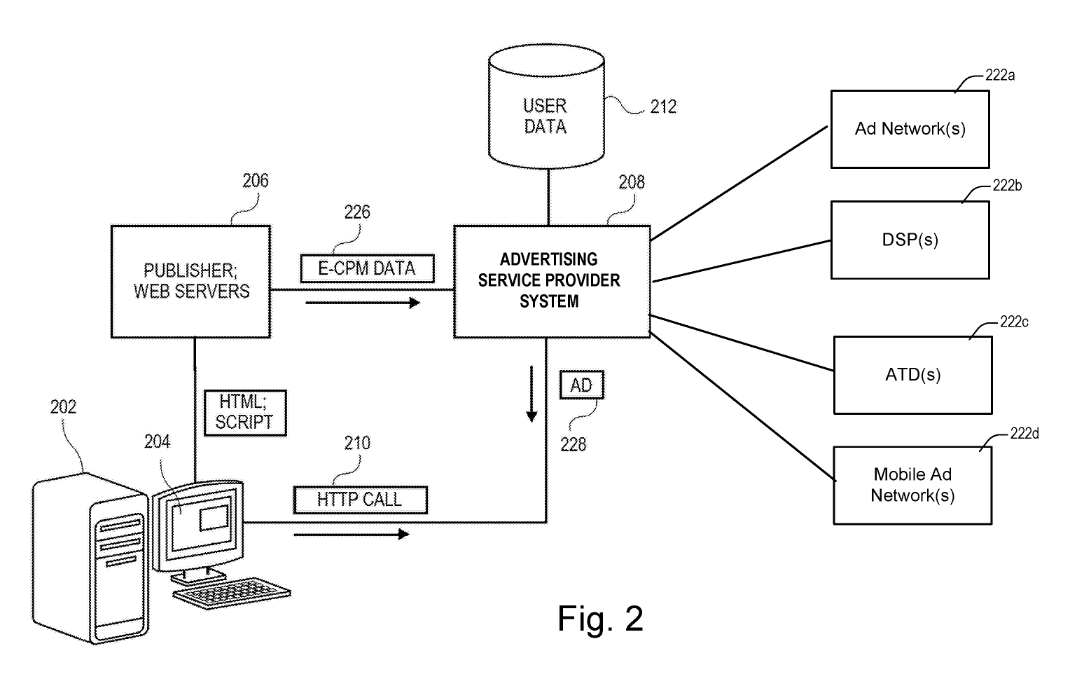

FIG. 2 is a block diagram showing an example embodiment of entities and interactions for implementing various aspects of the online advertising techniques disclosed herein. The example embodiment of FIG. 2 shows a user computing device 202 executing a browser 204. The user goes to a certain Web site 206, for example, a blog about traveling. Code for displaying the Web site executes in the user's browser 204. In the code there is a script for displaying an ad. The ad is served by an advertising service provider 208. An HTTP call 210 is made from user computing device 202 to advertising service provider 208 that contains a UID and an SID. The advertising service provider uses the SID and UID to retrieve information on the user. The advertising service provider may have data on more than 500 million unique users (individuals). The data it has on the individuals includes age range, gender, preferences, demographic information, geographic location, socio-economic data (e.g., income, nationality, race, etc.), among other data. The advertising service provider databases 212 may be indexed by UID to obtain user or segment data. This data is searched in real time. In one embodiment, the publisher's Web page may be held until the look-up and ad bidding is done. The Web page is displayed when an ad has been selected and is available to be served and displayed with the Web page.

The advertising service provider then places the ad spot for real-time bidding (RTB) (that is, it starts a bidding process) among various selected Ad Network(s), which, for example, may include, but are not limited to, one or more of the following (or combinations thereof): selected Ad Network(s) 222a, Demand-Side Platforms (DSPs) 222b, Agency Trading Desks (ATDs) 222c, ad campaign server(s), and/or other types of advertisers.

In some embodiments, audience segment level and ad type level may be used to derive permutations that can be used by publisher 206 to set floor e-CPMs. For example, these bidders may be notified that there is an ad spot available on a travel blog Web site that is being viewed by a user, for example, in the 45-55 age range, living in San Francisco, male, Asian, has an annual income above $55,000, and so on.

There are numerous types of data that can be offered about the user. The advertising service provider 208 may also state some requirements of the publisher 206, such as the quality of the ad (pixels, creatives, etc). The advertising entities (214-224) can then bid on the spot. One desirable objective may be to obtain a match between user demographic data and features with an ad spot on the Web page. The publisher is able to set floor e-CPMs on numerous permutations of which a few basic examples are described here. A person of skill in the art of online ad serving would know how to take the controls and preferences and create many other types of permutations and appropriate floor e-CPMs. There are also relationships that the publisher may have with DSPs, ATDs, etc. that can be used to set floor e-CPMs.

Typically, it is not efficient for most publishers to directly deal with advertisers or DSPs (or other ad serving entities), since publishers typically do not have the desire or capability to deal with 50 or a 100 ad serving entities and thousands of advertisers in real time to serve ads at e-CPMs that are acceptable to both sides. As a result, publishers typically rely upon ad service providers (e.g., ad servers) to facilitate this process.

Various aspects of advertising service provider techniques are described herein for enabling online publishers and content providers to have more granular control over setting e-CPM floor prices for ads served on their web sites and related web pages. In one embodiment, a Floor Rule Engine can be implemented, for example as a module of a system (referred to herein as an Advertising Service Provider Private Marketplace), which allows the publisher to set floor pricing at a granular level. The Floor Rule Engine allows the publisher to set the e-CPM floor price using any combination of different entities. Each such parameter is referred to as a rule. Rules can be prioritized as desired.

Without the advertising service provider, the publisher would not be able to effectively use these controls or use them at all to set e-CPM floors. However, this is now possible because the publisher has the benefit of the advertising service provider's ability to get a profile of the user/audience viewing the Web site in real-time. Finally, the ad 228 by the winning ad serving entity is served to user Web browser 204 and displayed in the Web page which can then complete loading.

As noted above, the number of parameters and categories that may be used to sell online ads has increased significantly. The advertising service provider is able to obtain and has stored massive amounts of data on hundreds of millions of users in its databases. Because of this large volume of data on users that is now available, the advertising service provider can enable the publisher a level of control in filling its ad spots that was previously not available. This information can be searched and the bidding process can occur as a Web page is loading. Once an ad has been selected (i.e., there is a winning bid), the ad is served by the advertising service provider to the user's browser and displayed on the Web page. That user is now presented with an ad that is very likely of high interest to him or her.

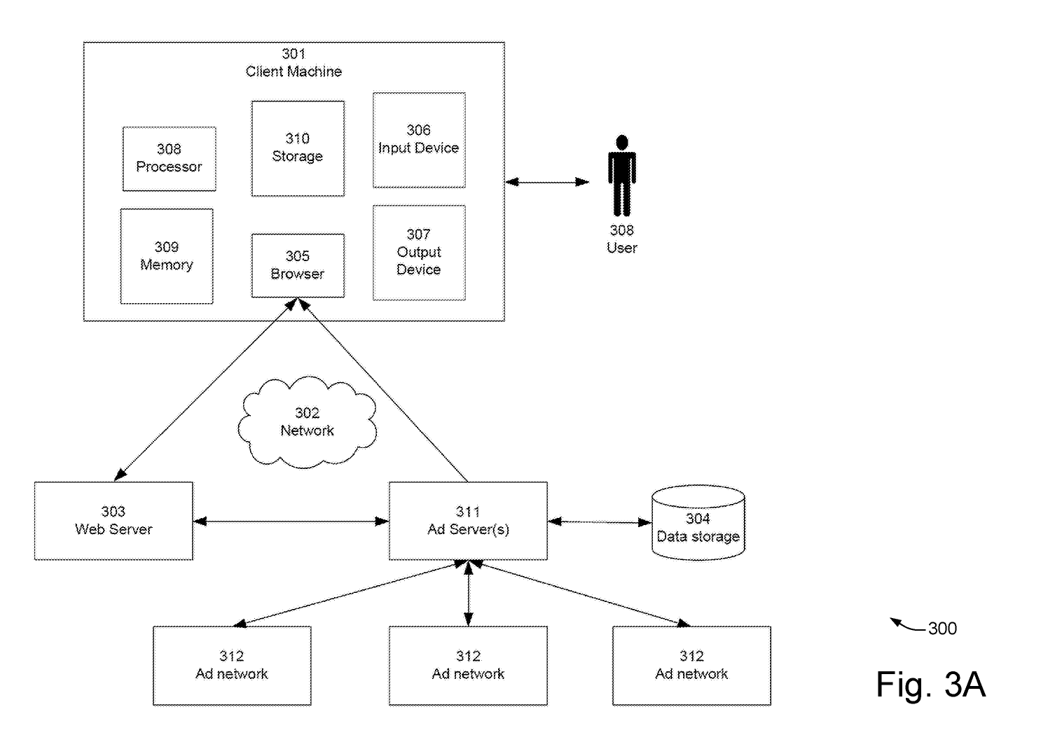

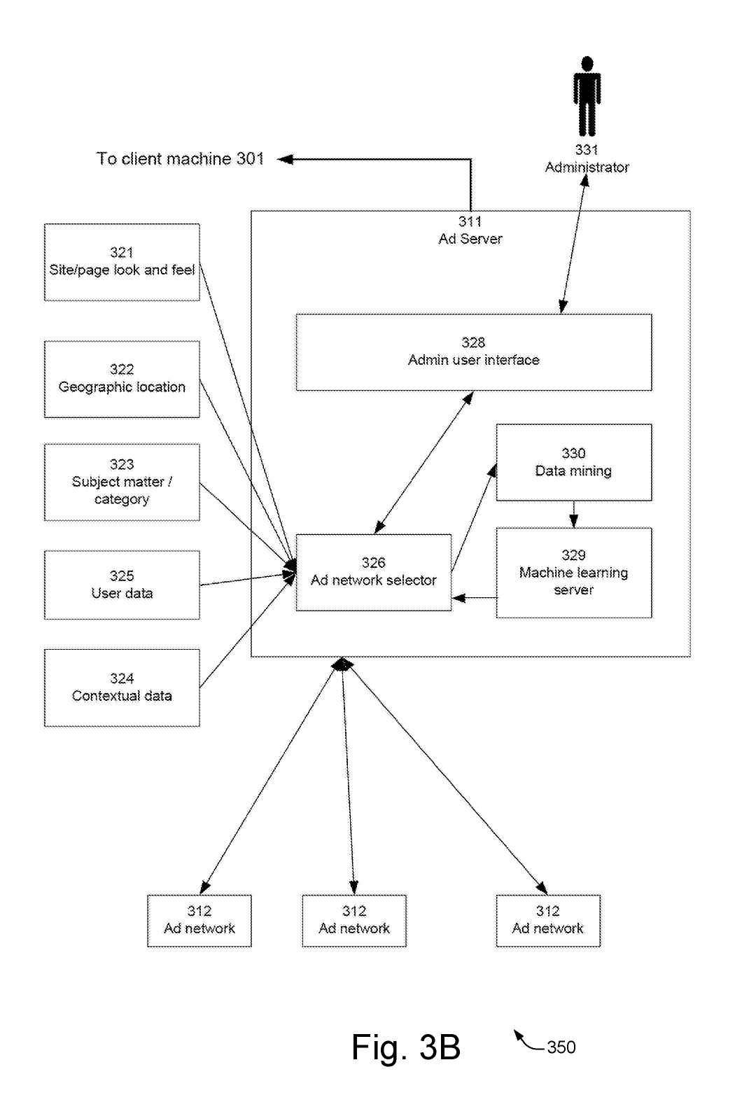

FIG. 3A is a block diagram depicting an overall architecture for implementing various aspects of the online advertising techniques disclosed herein. As illustrated in the example embodiment of FIG. 3A, client machine 301 communicates with server 303 across a network 302 such as the Internet, using well known protocols for such network communications. Client machine 301 can be a personal computer, computing device, or other electronic device such as a kiosk, telephone, cellular telephone, handheld computer, personal digital assistant, or the like. Client machine 301 includes, in one embodiment: processor 308; memory 309; storage 310; input device 306 such as a keyboard, mouse, touchpad, or the like; output device 307 such as a display screen; and other hardware components as are well known for computing devices and/or other electronic devices. Client machine 301 may run an operating system such as Microsoft Windows Vista, available from Microsoft Corporation of Redmond, Wash., or any other suitable operating system.

In one embodiment, browser software 305 runs on client machine 301 enabling user 308 to view content and interact with web pages available on the World Wide Web and delivered to client machine 301 via network 302. One example of browser 305 is Microsoft Internet Explorer, available from Microsoft Corporation of Redmond, Wash.

In one embodiment, an Advertising Service Provider System such as ad server 311 may be used for selecting an appropriate advertisement to be shown to user 308 along with the content provided by web server 303. According to different embodiments, ad server 311 may be configured as a single component or a plurality of separate components running at a single location or at one or more remote locations. Using browser 305, user 308 requests a web page from web server 303. Web server 303 may generate and send an ad request to ad server 311. The ad request may include a request for ad server 311 to provide an ad for placement with or alongside the content being provided to browser 305. As described in more detail below, ad server 311 makes a determination as to which ad network(s) 312 the ad should be requested from. Additional parameters may form part of the ad request, so that the selected ad network(s) 312 may each identify and provide one or more appropriate ad candidates based on context, user 308 characteristics, and/or other factors. According to different embodiments, the ad server 311 may obtains such information from data storage 304 and/or from one or more remote servers.

In at least one embodiment, the ad server 311 may send out one or more ad solicitation requests (herein referred to as “calls” or “hops”) to one or more ad network(s) 312 in order to solicit and select (from the various solicited ad networks) the most preferred ad for filling the ad request.

In one embodiment, the ad network 312 associated with the selected ad transmits the ad (or an identification of the ad) to ad server 311, and ad server obtains the ad and transmits it to browser 305 for display to user 308. In another embodiment, ad server 311 transmits the ad to web server 303, which integrates the ad with requested content and sends the integrated content to browser 305. In yet another embodiment, ad network 312 transmits the ad to browser 305 without relaying it through ad server 311. Whichever mechanism is used, the selected ad is displayed at output device 307 alongside requested content from web server 303.

The publisher of content at web server 303 can be compensated for the ad placement based on the relative effectiveness of the ad. Accordingly, it is advantageous for the ad selection process to yield ads that are more likely to be effective for a given user 308. In at least one embodiment, ad server 311 may be configured or designed to make an optimal selection among ad networks 312 so as to more effectively deliver ads that are of higher value.

FIG. 3B is a block diagram illustrating data flow for an embodiment for implementing various aspects of the online advertising techniques disclosed herein, including further details concerning the functional components of ad server(s) 311. For illustrative purposes, ad server 311 is depicted as a single entity; however, one skilled in the art will recognize that multiple ad servers 311 can be provided, each performing according to the techniques described herein.

In one embodiment, ad server 311 includes ad network selector 326, which may be implemented as software running on a processor at server 311 or on a different processor. Ad network selector 326 takes into account various factors in determining which ad network 312 to select for a particular website or content page being presented. Non-limiting examples of such factors may include, but are not limited to, one or more of the following (or combinations thereof):
site/page look and feel 321 (including cascading style sheets (CSS), colors, themes, and the like): this information can also be used for customizing the layout of the ad and for selection of ad colors, in order to maximize the click-through ratio (CTR);
geographic location 322 of user 308: this information is used for geographic targeting of advertisements;
subject matter or category 323 (also referred to as the “vertical”) of the site/page (such as gaming, technology, entertainment, news, etc.);
user data 325, such as may be retrieved from a UII File stored at client machine 301; and
contextual data 324, such as keywords on the content page: this information can be used for setting a bid price for advertisements;
etc.

In one embodiment, in selecting an ad network 312, ad network selector 326 takes into account ad network data 327 such as pricing data (or e-CPM), frequency, and the like. For example, ad network selector 326 can extract ad network pricing data from data 327. In one embodiment, ad network selector 326 makes use of data mining process 330 to extract relevant data. Data mining process 330 sends data to machine learning server 329 to analyze data for trends, and to revise prediction models based on new user and network data. Machine learning server 329 thereby generates decision parameters for use by ad network selector 326, and transmits such updated decision parameters to ad network selector 326 to communicate changes in the prediction model. In one embodiment, data mining and machine learning can take place off-line, using data from ad server 311. The results of these processes can be stored in a database (not shown) for later use by ad network selector 326. Machine learning server 329 and data mining process 330 can be implemented as part of ad server 311, or as separate components.

Admin user interface 328 is provided, to allow administrator 331 to view data, to manage and control the operation of selector 326 and other components of ad server 311, to make any manual overrides to the algorithms or processes, and/or to set any specific parameters.

Once ad server 311 has selected an ad network 312, in one embodiment it obtains the ad-code to be presented, and transmits the ad-code to web server 303. Client machine 301 retrieves the ad-code along with the content of the web page and then integrates the ad-code with the requested content. The ad-code then retrieves the actual ad content (such as images, video, and/or text) directly from the ad network 312 for presentation to user 308 via output device 307.

### Intelligent Ad Auctions Based on Demand Side Capabilities

In the mobile advertising space, ad serving latency can be a significant and problematic issue. Accordingly, various aspects disclosed herein are directed towards techniques for facilitating reduction of latency in the ad serving process, particularly those relating to Advertising Service Provider System(s).

In at least one embodiment, an Advertising Service Provider System (e.g., ad server(s) 311, FIG. 3) may be configured or designed to utilize one or more Intelligent Ad Auction (IA) ad serving technique(s) which may be based on demand-□side capabilities. For example, according to some embodiments, the Intelligent Ad Auction technique(s) may be configured or designed to perform ad solicitation calls to various selected API networks with maximum possible (or optimum) parallelization. Thus, for example, in some embodiments, the Intelligent Ad Auction technique may be configured or designed as an optimization technique to reduce latency in the ad serving process by concurrently sending selected ad solicitation requests to multiple different ad networks in parallel fashion.

Many ad networks (particularly those in the mobile advertising space) support API protocols, and are able to provide ad content (commonly referred to as “creative”) in real-time or near real-time. This category of networks may commonly be referred to as API-based ad networks. API-based ad networks may be further classified according to the respective counting mechanism used by each network for CPM tracking and accounting purposes. For example, in some embodiments, different API-based ad networks may be classified as either Beacon Based Counting (BBC) Networks or Server Side Counting Networks (also referred to herein as Non-Beacon Based Counting (NBBC) Networks).

Typically, a Non-Beacon Based Counting Network counts an impression (e.g., for CPM purposes) when it responds with a valid creative. This may also be referred to as Server based counting (e.g., an impression is counted once the creative is returned). Alternatively, a Beacon Based Counting Network counts an impression when the creative is rendered (e.g., via use of a beacon). For example, in Beacon Based Counting (BBC), an impression is counted by the network once the ad serving beacon is executed).

As noted above, the Intelligent Ad Auction technique(s) described herein may be employed to help reduce latency in the ad serving process by concurrently sending out selected ad solicitation requests (herein referred to as “calls” or “hops”) to multiple different ad networks in parallel fashion. However, in embodiments where Server Side Counting Networks are to be supported, it may be preferable to use a “hybrid-call” combination of parallel and serial calls to achieve optimum results. Example embodiments of various hybrid-call Intelligent Ad Auction techniques are described in greater detail below.

At least one embodiment of the Intelligent Ad Auction technique may be configured or designed to mitigate ad serving latency issues by dynamically varying the number of steps and/or calls to be implemented when responding to a given ad request. In some embodiments, the dynamic varying of the steps and/or calls to be implemented when responding to a given ad request may be based, at least partially, on an amount of time that the ad server determines that it has to respond to a particular ad solicitation request.

For example, in at least one embodiment, when an ad request is received (e.g., at an ad server configured or designed to implement aspects of the Intelligent Ad Auction techniques described herein), the ad server may respond by sending out one or more consecutive sets of parallel calls to selected sets or groups of advertiser(s)/Ad Network(s). For example, the ad server may send out a first set of calls (e.g., ad solicitation requests) to a first selected set of advertiser(s)/Ad Network(s) which, for example, may include one or more of the following (or combinations thereof): Real-Time Bidding (RTB) Ad Networks, demand partners, ad campaign servers, and/or other types of advertisers. If none of the received bids/responses from the first set of advertiser(s)/Ad Network(s) is higher than the e-CPM value of highest bidding Adnet/S2S, then one or more consecutive sets of parallel calls may be sent to selected sets or groups of Mobile Ad Networks (herein referred to as Mobile Display Networks (“Adnet”) or Server-to-Server Networks (“S2S”)), which, for example, may include Beacon Based Ad Networks (BBCs) and/or Non-Beacon Based Ad Networks (NBBCs). For example, in one embodiment, a second set of consecutive parallel calls may be sent to a selected set of Beacon Based Ad Networks which have been identified as having relatively higher associated e-CPMs than the highest e-CPM associated with any Server Based Counting Ad Network. Assuming that responses are received from one or more of the first set of Beacon Based Ad Network(s), the e-CPM value(s) associated with these response(s) may be compared to other e-CPM value(s) such as those associated with real-time bids (RTBs) and/or predefined ad campaigns (such as, for example, the ad server's AdFlex ad campaigns). In one embodiment, if either the RTB or ad campaign has a relatively higher e-CPM than the highest paying Beacon Based Ad Network response, the impression may be awarded to the RTB or ad campaign which has the relatively highest e-CPM value. If neither the RTBs nor ad campaigns have relatively higher e-CPM than the highest responding Beacon Based Ad Network, then, in one embodiment, the highest responding Beacon Based Ad Network may be awarded the impression. Alternatively, in some embodiments, if the ad server determines that there are additional Mobile Ad Networks that may pay higher than the response currently identified as offering the highest e-CPM, the ad server may choose to initiate and send additional set(s) of parallel calls to additional sets of Mobile Ad Networks, time permitting.

In some embodiments, additional automated efforts may be implemented to help ensure that a given threshold time for responding to an ad request is not exceeded. For example, subsequent ad solicitation request calls will not be made if the ad server determines that implementing such calls will cause the total ad request response time to exceed the ad request timeout value or other specified threshold time value. In some embodiments, the threshold value may be implemented as a variable/adjustable threshold hop value which, for example, may be set on an individual publisher (e.g., Site level) basis. In at least one embodiment, the threshold time value may be dynamically determined based on the terms of a Service Level Agreement (SLA) between the ad server entity/operator (e.g., advertising service provider) and the ad request entity (e.g., publisher). Additionally, in some embodiments, the last call before the response threshold time is reached may include a call to a guaranteed fill ad network (if available).

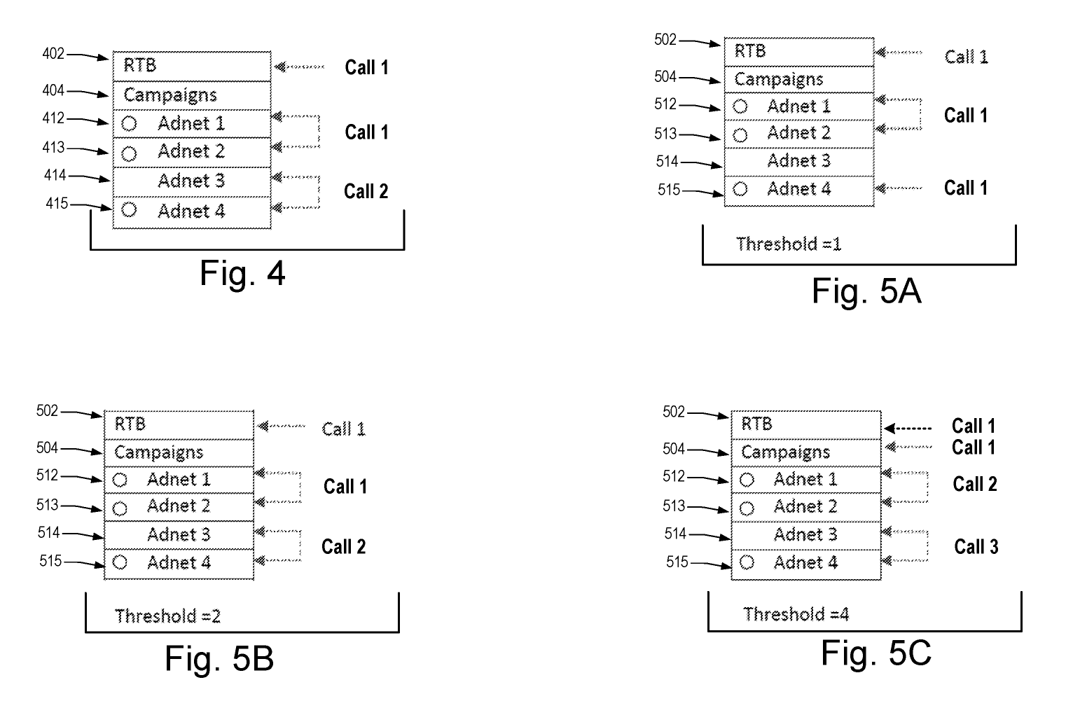

Additional aspects relating to the Intelligent Ad Auction techniques may be further described by way of illustration with reference to the example embodiments illustrated in FIGS. 4-10 of the drawings.

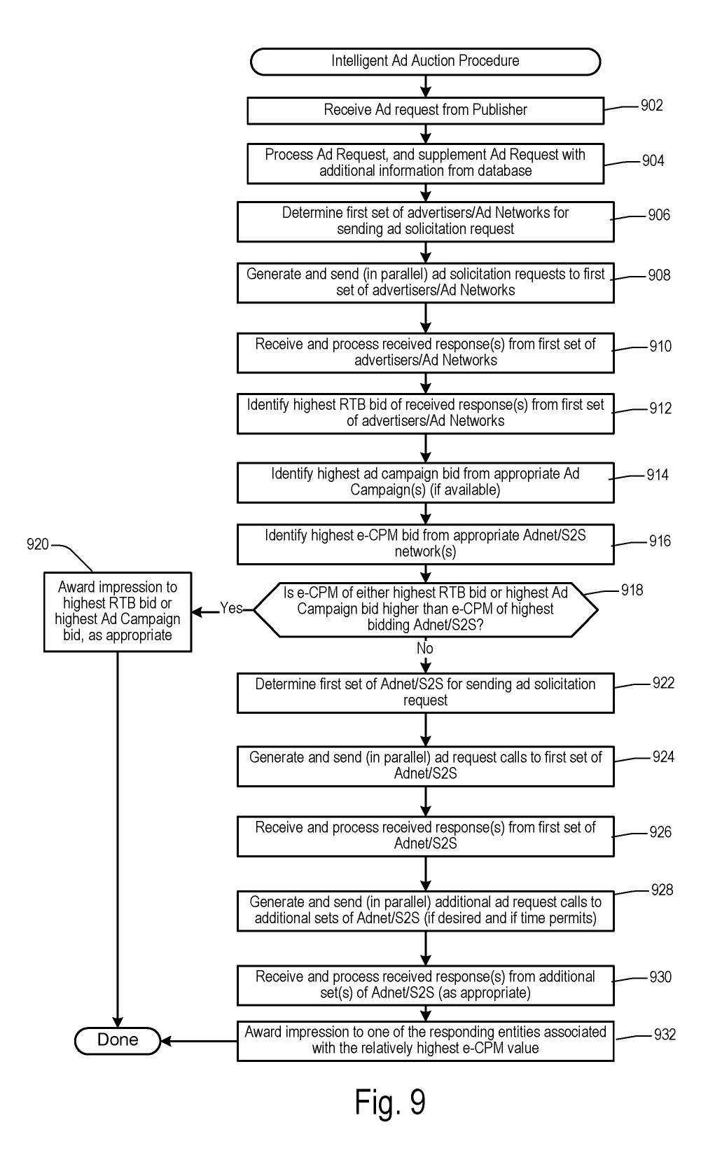

FIG. 9 shows a flow diagram of an Intelligent Ad Auction Procedure in accordance with a specific embodiment. According to different embodiments, at least a portion of the various types of functions, operations, actions, and/or other features provided by the Intelligent Ad Auction Procedure of FIG. 9 may be implemented at one or more one or more server system(s) such as, for example, Advertising Service Provider System (120, FIG. 1), ad server (311) and/or combinations thereof.

In at least one embodiment, the Intelligent Ad Auction Procedure may be operable to perform and/or implement various types of ad serving functions, operations, actions, and/or other features such as one or more of those described and/or referenced herein. The Intelligent Ad Auction Procedure may also be operable to utilize and/or generate various different types of data and/or other types of information when performing specific tasks and/or operations. This may include, for example, input data/information and/or output data/information. For example, in at least one embodiment, the Intelligent Ad Auction Procedure may be operable to access, process, and/or otherwise utilize information from one or more different types of sources, such as, for example, one or more local and/or remote memories, devices and/or systems. Additionally, in at least one embodiment, the Intelligent Ad Auction Procedure may be operable to generate one or more different types of output data/information, which, for example, may be stored in memory of one or more local and/or remote devices and/or systems. Examples of different types of input data/information and/or output data/information which may be accessed and/or utilized by the Intelligent Ad Auction Procedure may include, but are not limited to, one or more of those described and/or referenced herein.

In at least one embodiment, a given instance of the Intelligent Ad Auction Procedure may access and/or utilize information from one or more associated databases. At least a portion of the database information may be accessed via communication with one or more local and/or remote memory devices. Examples of different types of data which may be accessed by the Intelligent Ad Auction Procedure may include, but are not limited to, one or more of those described and/or referenced herein.

According to specific embodiments, multiple instances or threads of the Intelligent Ad Auction Procedure may be concurrently implemented and/or initiated via the use of one or more processors and/or other combinations of hardware and/or hardware and software. For example, in at least some embodiments, various aspects, features, and/or functionalities of the Intelligent Ad Auction Procedure may be performed, implemented and/or initiated by one or more of the various systems, components, systems, devices, procedures, processes, etc., described and/or referenced herein. According to different embodiments, one or more different threads or instances of the Intelligent Ad Auction Procedure may be initiated in response to detection of one or more conditions or events satisfying one or more different types of minimum threshold criteria for triggering initiation of at least one instance of the Intelligent Ad Auction Procedure. Various examples of conditions or events which may trigger initiation and/or implementation of one or more different threads or instances of the Intelligent Ad Auction Procedure may include, but are not limited to, one or more of those described and/or referenced herein. According to different embodiments, one or more different threads or instances of the Intelligent Ad Auction Procedure may be initiated and/or implemented manually, automatically, statically, dynamically, concurrently, and/or combinations thereof. Additionally, different instances and/or embodiments of the Intelligent Ad Auction Procedure may be initiated at one or more different time intervals (e.g., during a specific time interval, at regular periodic intervals, at irregular periodic intervals, upon demand, etc.).

In at least one embodiment, initial configuration of a given instance of the Intelligent Ad Auction Procedure may be performed using one or more different types of initialization parameters. In at least one embodiment, at least a portion of the initialization parameters may be accessed via communication with one or more local and/or remote memory devices. In at least one embodiment, at least a portion of the initialization parameters provided to an instance of the Intelligent Ad Auction Procedure may correspond to and/or may be derived from the input data/information.

For purposes of illustration, it is assumed that an instance of the Intelligent Ad Auction Procedure is running at the Advertising Service Provider System.

In at least one embodiment, when an ad request is received (e.g., at an ad server configured or designed to implement aspects of the Intelligent Ad Auction techniques described herein), the ad server may respond by sending out one or more consecutive sets of parallel calls to selected sets or groups of advertiser(s)/Ad Network(s). For example, the ad server may send out a first set of calls (e.g., ad solicitation requests) to a first selected set of advertiser(s)/Ad Network(s). If none of the received bids/responses from the first set of advertiser(s)/Ad Network(s) is higher than the e-CPM value of highest bidding Mobile Ad Network (herein referred to as Mobile Display Networks (“Adnet”) or Server-to-Server Networks (“S2S”)), then one or more consecutive sets of parallel calls may be sent to selected sets or groups of Mobile Ad Networks, which, for example, may include Beacon Based Ad Networks (BBCs) and/or Non-Beacon Based Ad Networks (NBBCs). In one embodiment, if either the RTB or ad campaign has a relatively higher e-CPM than the highest paying Mobile Ad Network, the impression may be awarded to the RTB or ad campaign which has the relatively highest e-CPM value. If neither the RTBs nor ad campaigns have relatively higher e-CPM than the highest responding Mobile Ad Network, then, in one embodiment, the highest responding Mobile Ad Network may be awarded the impression. Alternatively, in some embodiments, if the ad server determines that there are additional Mobile Ad Networks that may pay higher than the response currently identified as paying the highest e-CPM, the ad server may choose to initiate and send additional set(s) of parallel calls to additional sets of Mobile Ad Networks, based on the amount of time which the ad server determines is available.

Referring to the specific example embodiment of FIG. 9, at 902, it is assumed that a first Ad Request from a first publisher is received at the Advertising Service Provider System. According to different embodiments, the ad request may include various types of information about the impression and associated web page such as, for example, one or more of the following (or combinations thereof): URL, demographic info relating to user, geolocation of user, phone model, user data, etc.

At 904 the received Ad Request is processed and supplemented with additional information retrieved from one or more local and/or remote database(s). The processed ad request information and supplemental information may be used to determine and select (906) a first set of advertiser(s)/Ad Network(s) for sending ad solicitation request(s) relating to the first received ad request. In at least one embodiment, the ad solicitation request may include a request to solicit bids, offers, and/or creative for filling the impression associated with the received publisher's ad request.

According to different embodiments, the first set of advertiser(s)/Ad Network(s) may include one or more of the following (or combinations thereof):
RTB Ad Networks which participate in real-time bidding (or real-time ad auctioning) of impressions such as, for example, specific advertisers and/or demand partners.
Ad campaign servers (e.g., such as, for example, the ad server's AdFlex Ad Campaign System).
Mobile Ad Networks herein referred to as Mobile Display Networks (“Adnet”) or Server-to-Server Networks (“S2S”), which, according to different embodiments, may include Beacon Based Ad Networks (BBCs) and/or Non-Beacon Based Ad Networks (NBBCs).

At 908, a first set of ad solicitation requests may be generated and sent (in parallel) to the first set of advertiser(s)/Ad Network(s). In at least one embodiment, the ad solicitation request may include a timeout value specifying a maximum time period (e.g., 120 ms) for responding to the ad solicitation request.

In the specific example embodiment of FIG. 9, at 910, it is assumed that one or more of the first set of advertiser(s)/Ad Network(s) responds to the ad solicitation request. An advertiser/Ad Network which receives the ad solicitation request may process request in the allotted time period, and may reply or respond with a bid. According to different embodiments, a response or bid received from a given advertiser/Ad Network may include, for example, an e-CPM amount (or other information indicating an amount that the bidder is willing to pay for the impression), ad content (herein referred to as “creative”), and/or other information described and/or referenced herein.

The received responses(s) from first set of advertiser(s)/Ad Network(s) may each be processed, and the response with the highest paying e-CPM may be identified. In at least one embodiment, such processing may include one or more of the following activities (or combinations thereof), when appropriate: identifying (912) the highest RTB bid (e.g., highest paying e-CPM RTB response) from the received response(s) from the first set of advertiser(s)/Ad Network(s); and/or identifying (914) the highest ad campaign bid (e.g., highest paying e-CPM ad campaign response) from Ad Campaign(s) which were included in the first set of advertiser(s)/Ad Network(s).

As shown at 916, 918, the highest e-CPM bid from appropriate Adnet/S2S network(s) may be identified and a determination may be made as to whether (or not) the identified response with the highest paying e-CPM value is higher than the e-CPM value of highest bidding Adnet/S2S. For example, as illustrated in the example embodiment of FIG. 9, as shown at 918, a determination may be made as to whether (or not) the e-CPM value of either highest paying RTB bid or highest paying Ad Campaign bid is higher than the e-CPM value of highest bidding Adnet/S2S.

If it is determined that the e-CPM value of either highest paying RTB bid or highest paying Ad Campaign bid is higher than the e-CPM value of highest bidding Adnet/S2S, the impression may be awarded (920) the highest RTB bid or to the highest Ad Campaign bid, as appropriate.

Alternatively, if it is determined that that none of the received bids/responses from the first set of advertiser(s)/Ad Network(s) is higher than the e-CPM value of highest bidding Adnet/S2S, then one or more consecutive sets of parallel calls may be sent to selected sets or groups of Adnet/S2S networks. As illustrated in the example embodiment of FIG. 9, this may include, but is not limited to, initiating or performing one or more of the following activities (or combinations thereof):
Determining (e.g., identifying and selecting) (922) a first set of Adnet/S2S networks for sending ad request calls relating to the received ad request.
Generating and sending (in parallel) (924) ad request calls to the first set of Adnet/S2S networks.
Processing (926) received response(s) from first set of Adnet/S2S networks.
Generating and sending (in parallel) (928) additional ad request calls to additional sets of Adnet/S2S networks (if desired and time permits). For example, if the Advertising Service Provider System determines that there are additional Mobile Ad Networks that may pay higher than the response currently identified as offering the highest e-CPM, the ad server may choose to initiate and send additional set(s) of parallel calls to additional sets of Mobile Ad Networks, based upon the amount of time which the Advertising Service Provider System determines to be available.
Process (930) received response(s) from additional set(s) of Adnet/S2S, as appropriate.

As shown at 932, the impression (associated with the received ad request) may be awarded to one of the responding entities (e.g., advertiser, Ad Network, Adnet/S2S network, ad campaign, etc.) associated with the relatively highest e-CPM value.

It will be appreciated that different embodiments of the Intelligent Ad Auction Procedure (not shown) may include additional features and/or operations than those illustrated in the specific embodiment of FIG. 9, and/or may omit at least a portion of the features and/or operations of Intelligent Ad Auction Procedure illustrated in the specific embodiment of FIG. 9.

Additional aspects relating to the Intelligent Ad Auction Procedure of FIG. 9 may be described by way of illustration with reference to the example embodiments illustrated in FIGS. 4-8B of the drawings.

FIGS. 4-8B show different example scenarios illustrating how the Intelligent Ad Auction Procedure may go about handling the filling of a publisher ad request under different types of circumstances and conditions. In the example embodiment of FIGS. 4-8B, the BBC-based Adnets are indicated by an adjacent circle icon (“o”). Thus, for example, in the specific example embodiment of FIGS. 4 and 5A-C, Adnet 1 (412), Adnet 2 (413), and Adnet 4 (415) correspond to BBC Mobile Display Networks, and Adnet 3 (414) corresponds to a Non-Beacon Based (NBBC) Mobile Display Network. Additionally, in the specific example embodiment of FIGS. 4-8B, it is assumed, for purposes of illustration, that Adnets displayed in each Figure have been sorted in descending order based on each Adnet's associated e-CPM value(s) (e.g., with Adnet having relatively highest e-CPM value at top).

In the specific example embodiment of FIG. 4, it is assumed that the Advertising Service Provider System receives an ad request from a publisher to fill an ad associated with a first web page impression. In one embodiment, the Advertising Service Provider System may respond to the received ad request by initially sending out a first set of concurrent calls (e.g., in parallel) (“Call 1”) to a first plurality of advertiser(s)/Ad Network(s) which may include one or more RTB Networks (402). In some embodiments, the first plurality of advertiser(s)/Ad Network(s) may also include selected Beacon Based Ad Network(s) and/or Server Based Counting Ad Network(s). For example, as illustrated in the example embodiment of FIG. 4, the Advertising Service Provider System may send out the first set of parallel calls (“Call 1”) to a first plurality of advertiser(s)/Ad Network(s) which includes selected RTB Network(s) (402), and any BBC-based Adnets (e.g., Adnet 1, 412; Adnet 2, 413) whose respective e-CPM value is greater than (or equal to) the e-CPM value associated with the highest bidding NBBC-based Adnet (e.g., 414).

In one embodiment, if Adnet1 (412) and Adnet 2 (413) each send back default/no ad responses then the Advertising Service Provider System may initiate and send out a second set of parallel calls (“Call 2”) to a second group of Adnets. For example, as illustrated in the example embodiment of FIG. 4, the Advertising Service Provider System may initiate and send out a second set of parallel calls (“Call 2”) to a second group of Adnets, namely NBBC-based Adnet 3 (414) and BBC-based Adnet 4 (415). Each set of parallel call requests may be referred to as “hops.”

In one embodiment, the second set of Ad Networks may by dynamically identified and selected to include the Server Based Counting Ad Network with the highest associated e-CPM bid (e.g., NBBC-based Adnet 3) and one or more Beacon Based Ad Network(s) which each have a respective e-CPM bid that is higher than the next highest Server Based Counting Ad Network e-CPM bid. If one or more of the second set of Ad Networks respond, the highest paying Ad Network may be awarded the impression. If time permits, additional Ad Network calls may be made in a similar manner.

In at least one embodiment, for each subsequent hop, the selected Adnet/S2S networks may include the next highest set of consecutive BBC-based Adnet/S2S networks and the next highest NBBC-based Adnet/S2S network (e.g., raked by e-CPM). Thus, for example, in one embodiment, each subsequent group of Adnet/S2S networks (for a given hop) may include one NBBC-based Adnet/S2S network and either zero, one, or multiple BBC-based Adnet/S2S network(s).

In at least some embodiments, the Advertising Service Provider System may impose a “Call Threshold” value to limit the number of parallel calls which may be made for a given ad request. For example, a Call Threshold value (also referred to herein as “Threshold”) may be set to 1, 2, 3, 4, 5, etc. According to different embodiments, multiple different Call Threshold values may be assigned to different ad requests, publishers, web site domains, etc. In one embodiment, the Advertising Service Provider System be configured or designed to use a default Call Threshold value for handling all or selected ad requests.

FIGS. 5A-8B illustrate various example scenarios illustrating how the Advertising Service Provider System may handle the filling of a publisher ad request under differing Call Threshold conditions.

In the specific example embodiment of FIG. 5A, it is assumed that the Call Threshold value is set to Threshold=1, meaning that the Advertising Service Provider System may only generate and send out one set of parallel calls to selected advertiser(s)/Ad Network(s). Thus, in this particular example, the first and only set of parallel calls is sent to RTB network(s) 502 and all (or selected) BBC-based Adnet/S2S networks (e.g., regardless of the respective e-CPM bid associated with each BBC-based Adnet/S2S network).

In the specific example embodiment of FIG. 5B, it is assumed that the Call Threshold value is set to Threshold=2, meaning that the Advertising Service Provider System may generate and send out up to two consecutive sets of parallel calls to selected advertiser(s)/Ad Network(s). Accordingly, as shown in this particular example, the Advertising Service Provider System may generate and send out a first set of parallel calls (Call 1) to RTB Network(s) (502), BBC-based Adnet 1 (512), and BBC-based Adnet 2 (513), and then generates and sends out a second set of parallel calls (Call 2) to NBBC-based Adnet 3 (514), and BBC-based Adnet 4 (515). This may be referred to as sending out two calls to demand partners.

In the specific example embodiment of FIG. 5C, it is assumed that the Call Threshold value is set to Threshold=4, meaning that the Advertising Service Provider System may generate and send out up to four consecutive sets of parallel calls to selected advertiser(s)/Ad Network(s). As shown in this particular example, the Advertising Service Provider System may generate and send out a first set of parallel calls (Call 1) to selected RTB Network(s) (502) and Ad Campaign server(s) (504). Thereafter, the Advertising Service Provider System generates and sends out a second set of parallel calls (Call 2) to BBC-based Adnet 1 (512), and BBC-based Adnet 2 (513). Thereafter, the Advertising Service Provider System generates and sends out a third set of parallel calls (Call 3) to NBBC-based Adnet 3 (514), and BBC-based Adnet 4 (515). Although not specifically shown in FIG. 5C, if the Advertising Service Provider System determines that it is desirable to send out another set of calls to additional advertiser(s)/Ad Network(s), it may generate and send out a fourth set of parallel calls to selected additional Adnet/S2S networks (provided that there is sufficient time available).

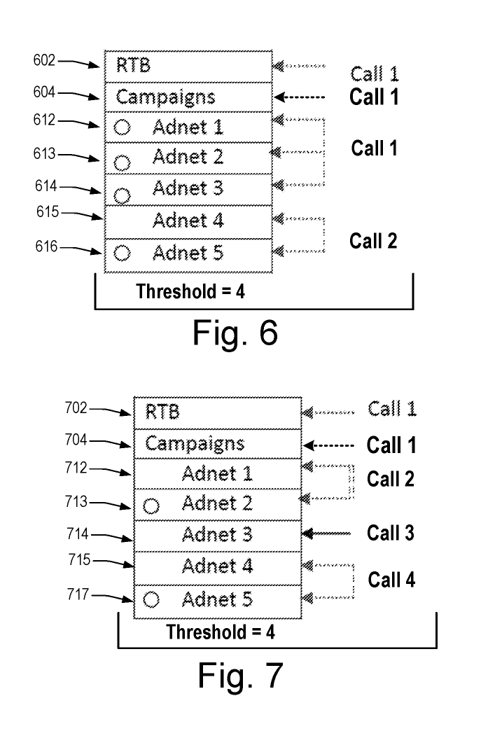

In the specific example embodiment of FIG. 6, it is assumed that the Call Threshold value is set to Threshold=4. In this particular example, the Advertising Service Provider System may generate and send out a first set of parallel calls (Call 1) to selected RTB Network(s) (602), Ad Campaign server(s) (604). Additionally, in this particular example, it is assumed that BBC-based Adnets 1, 2, 3 (612, 613, 614) each have a respective e-CPM bid which is greater than (or equal to) the e-CPM bid associated with the highest bidding NBBC-based Adnet (e.g., 615). Since the Advertising Service Provider System is not charged for soliciting bids from BBC-based Adnet/S2S networks (because Beacon Based Counting Networks only count an impression when the creative is rendered), the Advertising Service Provider System may also may also elect to include BBC-based Adnets 1, 2, 3 (612, 613, 614) in the first set of advertiser(s)/Ad Network(s) to be sent the first set of parallel calls (Call 1).

In one embodiment, if at least one response is received from any of the first set of solicited advertiser(s)/Ad Network(s) (e.g., RTB Network(s) (602), Ad Campaign server(s) (604), and/or Adnets 1, 2, 3 (612, 613, 614)) specifying an e-CPM bid that is higher than the highest bidding NBBC-based Adnet/S2S network (e.g., 615), then the impression may be awarded to the highest responding bidder, and no further calls need be made for serving the ad request. Alternatively, if no responses are received from the first set of advertiser(s)/Ad Network(s), or if none of the responses received from the first set of advertiser(s)/Ad Network(s) specifies an e-CPM bid that is higher than the highest bidding NBBC-based Adnet/S2S network (e.g., 615), then the Advertising Service Provider System may generate and send out a second set of parallel calls (Call 2) to NBBC-based Adnet 4 (615) and BBC-based Adnet 5 (616). Thereafter, if the Advertising Service Provider System dynamically determines that it is desirable to send out another set of calls to additional Adnet/S2S networks, it may generate and send out a third set (and possibly fourth set) of parallel calls to selected additional Adnet/S2S networks (provided that there is sufficient time available).

In the specific example embodiment of FIG. 7, it is assumed that the Call Threshold value is set to Threshold=4. In this particular example, the Advertising Service Provider System may generate and send out a first set of parallel calls (Call 1) to selected RTB Network(s) (702) and Ad Campaign server(s) (704). If at least one response is received from any of the solicited RTB Network(s) (702) or Ad Campaign server(s) (704), then the impression may be awarded to the highest responding bidder, and no further calls need be made for serving the ad request. If no responses are received from the first set of solicited advertiser(s)/Ad Network(s), or if none of the responses received from the first set of solicited advertiser(s)/Ad Network(s) specifies an e-CPM bid that is higher than the highest bidding Adnet/S2S network, then the Advertising Service Provider System may generate and send out a second set of parallel calls (Call 2) to NBBC-based Adnet 1 (712) and any identified BBC Adnet(s) (e.g., Adnet 2, 713) which has an associated e-CPM bid that is higher than the next highest bidding NBBC Adnet (e.g., Adnet 3, 714). Thereafter, if the Advertising Service Provider System dynamically determines that it is desirable to send out another set of calls to additional Adnet/S2S networks, it may generate and send out a third set (and possibly fourth set) of parallel calls to selected additional Adnet/S2S networks (provided that there is sufficient time available. Thus, as illustrated in the example embodiment of FIG. 7A, the Advertising Service Provider System may generate and send out a third set of parallel calls to NBBC-based Adnet 3 (714), and may generate and send out a fourth set of parallel calls to NBBC-based Adnet 4 (715) and BBC-based Adnet 5 (717).

According to different embodiments, this process may repeat with subsequent calls to additional advertiser(s)/Ad Network(s) until one or more specific conditions and/or events is detected such as, for example, one or more of the following (or combinations thereof):
the specified Call Threshold value has been reached;
an ad network responds with a non-default response;
it is determined that there is insufficient time to initiate any additional calls to additional advertiser(s)/Ad Network(s) (e.g., due to ad response timeout constraints);
etc.

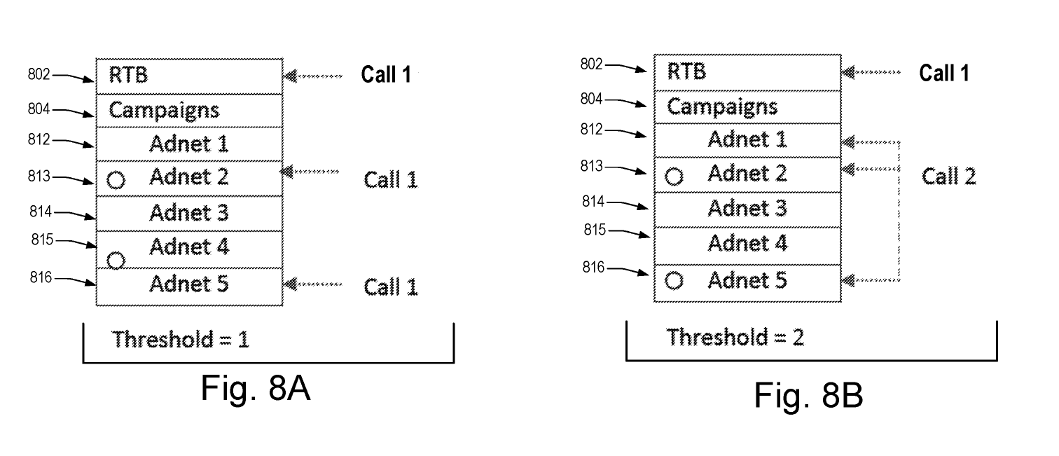

In the specific example embodiment of FIG. 8A, it is assumed that the Call Threshold value is set to Threshold=1. In this example scenario, the Advertising Service Provider System may only make one set of ad solicitation request calls to demand partners to serve an ad. Accordingly, in this particular example, the first (and only) set of parallel calls is sent to RTB network(s) 802 and all (or selected) BBC-based Adnet/S2S networks (e.g., 813, 816), regardless of the relative amounts e-CPM bids associated with each BBC-based Adnet/S2S network.

In the specific example embodiment of FIG. 8B, it is assumed that the Call Threshold value is set to Threshold=2, meaning that the Advertising Service Provider System may make two sets of parallel ad solicitation request call to demand partners to serve an ad. Accordingly, in this particular example, the Advertising Service Provider System may generate and send a first set of calls (Call 1) to RTB Networks (802), and may generate and send a second set of calls (Call 2) to the highest bidding NBBC Adnet/S2S network (e.g., Adnet 1, 812) and all (or selected) BBC Adnet/S2S networks (e.g., 813, 816). In at least some embodiments, if at least one response is received from any of the solicited RTB Network(s) (802) specifying an e-CPM bid that is higher than the highest bidding Adnet/S2S network (e.g., Adnet 1, 812), then the impression may be awarded to the highest responding bidder, and the second set of calls need not be implemented by the Advertising Service Provider System.

One advantage of the Intelligent Ad Auction techniques described herein is that by implementing concurrent, parallel calls to multiple different ad networks, latency/ad serving time may be significantly reduced (as compared to traditional serial call ad serving techniques).

Another advantage of the Intelligent Ad Auction techniques described herein is that implementation of such techniques helps to facilitate a reduction in the number of calls which may be required to be made from the client or user's device/system.

Yet another advantage of the Intelligent Ad Auction techniques described herein is that implementation of such techniques helps to facilitate improved default handling at ad server side. For example, when a solicited ad network defaults, instead of sending the defaulted response to the user device and initiating new ad solicitation request, the Intelligent Ad Auction technique may be adapted to handle the defaults on the server side (e.g., Advertising Service Provider Server(s)). In some embodiments, this default handling technique may be particularly advantageous in API-based networks.

### SLA Compliance and Response Latency Timeout

Premium publishers often insist that advertising service providers sign a Service Level Agreement (SLA) with the Publisher which commits the advertising service provider to a specific latency (herein referred to as a “SLA Response Timeout”, or more generally as a “Response Latency Timeout”) for ad-serving purposes. Typically, the Response Latency Timeout may be measured in terms of milliseconds, starting from the time that the ad request is sent from the Publisher's server (or end user's device) to the advertising service provider, and ending when the response (e.g., sent from the advertising service provider's ad server) is received at the Publisher's server (or end user's device). For example, an SLA may specify a SLA Response Timeout value of 500 ms. The Publisher may cut off or cancel the ad request after the SLA Response Timeout has expired. For example, a connection to the Publisher's server may be automatically closed after SLA Response Timeout period has been exceeded. This may result in loss of revenue to the advertising service provider, loss of computing resources at the advertising service provider's ad server, and/or a decrease in the advertising service provider's fill-rate, all of which are undesirable to advertising service provider.

In light of these issues, one or more aspects disclosed herein are directed to various SLA compliance and fulfillment techniques which may be implemented at Advertising Service Provider Systems and ad servers for intelligently handling ad requests in a manner which helps to ensure that a given Publisher's ad request is timely filled and the ad served within the specified SLA Response Timeout period.

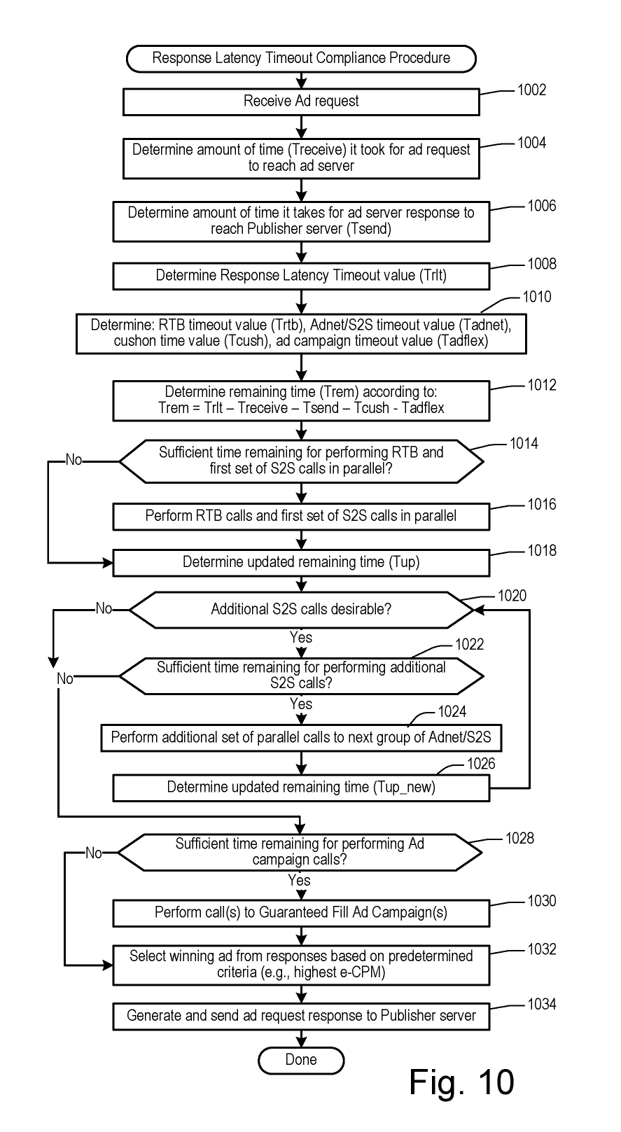

FIG. 10 shows a flow diagram of a Response Latency Timeout Compliance Procedure 1000 in accordance with a specific embodiment. According to different embodiments, at least a portion of the various types of functions, operations, actions, and/or other features provided by the Response Latency Timeout Compliance Procedure of FIG. 10 may be implemented at one or more one or more server system(s) such as, for example, Advertising Service Provider System (120, FIG. 1), ad server (311) and/or combinations thereof.

In at least one embodiment, the Response Latency Timeout Compliance Procedure may be operable to perform and/or implement various types of ad serving functions, operations, actions, and/or other features such as one or more of those described with respect to the Intelligent Ad Auction Procedure of FIG. 9. Additionally, the Response Latency Timeout Compliance Procedure may further be operable to perform and/or implement various types of SLA compliance and fulfillment techniques for intelligently handling ad requests in a manner which helps to ensure that a given Publisher's ad request is timely responded to within the specified SLA Response Timeout period, while simultaneously seeking to maximize the monetization of the impression.

According to different embodiments, the Response Latency Timeout Compliance Procedure may be operable to utilize and/or generate various different types of data and/or other types of information when performing specific tasks and/or operations. This may include, for example, input data/information and/or output data/information. For example, in at least one embodiment, the Response Latency Timeout Compliance Procedure may be operable to access, process, and/or otherwise utilize information from one or more different types of sources, such as, for example, one or more local and/or remote memories, devices and/or systems. Additionally, in at least one embodiment, the Response Latency Timeout Compliance Procedure may be operable to generate one or more different types of output data/information, which, for example, may be stored in memory of one or more local and/or remote devices and/or systems. Examples of different types of input data/information and/or output data/information which may be accessed and/or utilized by the Response Latency Timeout Compliance Procedure may include, but are not limited to, one or more of those described and/or referenced herein.

In at least one embodiment, a given instance of the Response Latency Timeout Compliance Procedure may access and/or utilize information from one or more associated databases. At least a portion of the database information may be accessed via communication with one or more local and/or remote memory devices. Examples of different types of data which may be accessed by the Response Latency Timeout Compliance Procedure may include, but are not limited to, one or more of those described and/or referenced herein.

According to specific embodiments, multiple instances or threads of the Response Latency Timeout Compliance Procedure may be concurrently implemented and/or initiated via the use of one or more processors and/or other combinations of hardware and/or hardware and software. For example, in at least some embodiments, various aspects, features, and/or functionalities of the Response Latency Timeout Compliance Procedure may be performed, implemented and/or initiated by one or more of the various systems, components, systems, devices, procedures, processes, etc., described and/or referenced herein. According to different embodiments, one or more different threads or instances of the Response Latency Timeout Compliance Procedure may be initiated in response to detection of one or more conditions or events satisfying one or more different types of minimum threshold criteria for triggering initiation of at least one instance of the Response Latency Timeout Compliance Procedure. Various examples of conditions or events which may trigger initiation and/or implementation of one or more different threads or instances of the Response Latency Timeout Compliance Procedure may include, but are not limited to, one or more of those described and/or referenced herein. According to different embodiments, one or more different threads or instances of the Response Latency Timeout Compliance Procedure may be initiated and/or implemented manually, automatically, statically, dynamically, concurrently, and/or combinations thereof. Additionally, different instances and/or embodiments of the Response Latency Timeout Compliance Procedure may be initiated at one or more different time intervals (e.g., during a specific time interval, at regular periodic intervals, at irregular periodic intervals, upon demand, etc.).

In at least one embodiment, initial configuration of a given instance of the Response Latency Timeout Compliance Procedure may be performed using one or more different types of initialization parameters. In at least one embodiment, at least a portion of the initialization parameters may be accessed via communication with one or more local and/or remote memory devices. In at least one embodiment, at least a portion of the initialization parameters provided to an instance of the Response Latency Timeout Compliance Procedure may correspond to and/or may be derived from the input data/information.

For purposes of illustration, it is assumed that an instance of the Response Latency Timeout Compliance Procedure is running at an ad server of Advertising Service Provider System (120, FIG. 1).

Referring to the specific example embodiment of FIG. 10, at 1002, it is assumed that a first Ad Request from a first publisher is received at the Advertising Service Provider System. According to different embodiments, the ad request may include various types of information about the impression and associated web page such as, for example, one or more of the following (or combinations thereof): URL, demographic info relating to user, geolocation of user, phone model, user data, timestamp information, etc. The received Ad Request may processed by the ad server and supplemented with additional information retrieved from one or more local and/or remote database(s).

In at least one embodiment, the Advertising Service Provider System may be configured or designed to measure the time taken for a Publisher's ad request to reach the Advertising Service Provider System's ad server, and estimate the time required to return a response. This estimated round trip Request/Return time may be subtracted from the permitted latency (e.g., as specified by the SLA Response Timeout value), and the remaining time which is calculated may be used for the ad server to monetize the impression. For example, in at least one embodiment, ad serving for mobile impressions may include at least the following activities:
Time taken for the ad request from the publisher server/browser to reach the ad server;
Time taken to hold an RTB auction (e.g., 160 ms);
Time taken to conduct a guaranteed fill ad campaign (e.g., Adflex) auction (e.g., 30 ms)
Time taken for conducting an Adnet/S2S network call (e.g., 200 ms×number of hops)

As shown at 1004, the ad server may determine an amount of time (Treceive) it took for the ad request to reach the ad server, as measured from the time it was sent from the Publisher server. Additionally, as shown at 1006, the ad server may determine an amount of time (Tsend) it will take for an ad server response to reach the Publisher server.

According to different embodiments, the ad server may use a variety of techniques for measuring and/or determining the Treceive value and Tsend value, such as, for example, one or more of the following (or combinations thereof):
Using the timestamp information from the received ad request;
Periodically ping the Publisher's server(s) to determine latency;
Request timing statistics from the Publisher. An example of one such a request is illustrated below:
   w“%{time_namelookup}\t %{time_connect}\t %{time_appconnect}\t %{time_pretransfer}\t %{time_redirect}\t %{time_starttransfer}\t %{time_total}\n” -o/dev/null -s “http://www.google.com”
and/or other techniques which may be used to determine latency between the Publisher server and the ad server.

In at least one embodiment, the determination of the Treceive and/or Tsend values may depend on various environmental factors such as, for example, the geographic location of the ad request, the network type (e.g., wifi, 3g, 4g, etc.).

In at least one embodiment, the Publisher may be requested (e.g., during a certification process) to sync the local time of the Publisher's server(s) to a common time reference signal, such as that provided by the well-known NTP pool (www.pool.ntp.org). This helps to ensure that the Publisher's servers are synced with Advertising Service Provider System's servers.

As shown at 1008, the ad server may determine a Response Latency Timeout value (Trlt) associated with the received ad request. In one embodiment, the Response Latency Timeout value may correspond to a SLA Response Timeout value. For example, in one embodiment, the ad sever may determine the identity of the Publisher associated with the received ad request (e.g., using Publisher ID parameter of ad request), and may then perform a lookup at one or more local and/or remote database(s) to determine whether there is a specific SLA Response Timeout value associated with the identified Publisher. In some embodiments, if no specific SLA Response Timeout value is associated with the identified Publisher, then a predetermined default Response Timeout value may be used (such as, for example, 500 msec). In other embodiments, the Trlt value may be determined based on one or more different Response Latency Timeout value(s) associated with other parameters of the ad request such as, for example, one or more of the following (or combinations thereof):
Web Domain parameter;
Server IP Address parameter;
Publisher ID parameter;
Response Time Out Latency parameter (if available)
and/or other parameter(s) which may be used to determine a Response Latency Timeout value associated with the ad request.
   As shown at 1010, the ad server may determine other time constraint values, such as, for example, one or more of the following (or combinations thereof):
An RTB timeout value (Trtb), which, for example, may correspond to a specific timeout value to be used in conjunction with ad solicitation requests/calls sent to RTB Network(s). For example, according to different embodiments, the Trtb value may be determined to be a value within the range of about 100 ms to 300 ms (e.g., 140 ms, 160 ms, etc.).
An Adnet/S2S timeout value (Tadnet), which, for example, may correspond to a timeout value to be used in conjunction with ad solicitation requests sent to Adnet/S2S network(s). For example, according to different embodiments, the Tadnet value may be determined to be a value within the range of about 100 ms to 300 ms (e.g., 150 ms, 200 ms, etc.).
An ad campaign timeout value (Tadflex), which, for example, may correspond to a timeout value to be used in conjunction with ad solicitation requests sent to ad campaign servers and/or guaranteed fill ad networks. For example, according to different embodiments, the Tadflex value may be determined to be a value within the range of about 10 ms to 50 ms (e.g., 30 ms, 35 ms, etc.).
A cushion time value (Tcush), which, for example, may correspond to an additional time period to be used as a “cushion” in order to provide additional flexibility in the Intelligent Ad Auction process. For example, according to different embodiments, the Tcush value may be determined to be a value within the range of about 5 ms to 50 ms (e.g., 10 ms, 30 ms, etc.).

For purposes of illustration and explanation, it may be assumed in the example of FIG. 10 that the ad server has determined the following time-related values (to be used in connection with filling the received ad request):
Response Latency Timeout value (Trlt)=500 ms;
Treceive=115 ms;
Tsend=110 ms
Trtb=140 ms
Tadnet=200 ms (per hop)
Tadflex=20 ms
Tcush=10 ms

In at least one embodiment, the statistics of the ad request may be taken into consideration, and depending on the time remaining to fulfill the SLA, an advertising service provider may optimize the ad-serving such that the priority is on fulfilling the SLA.

As shown at 1012, the ad server may determine or calculate (e.g., in real-time) a remaining time value (Trem) representing the remaining time for servicing and filling the received ad request, after taking into account the various determined time parameters. In at least one embodiment, the Trem value may be automatically and/or dynamically calculated by the ad server according to:

Trem=Trlt−Treceive−Tsend−Tcush−Tadflex (1)

Using the example time-related values as described above, the Trem value may be calculated according to:

$$\begin{matrix}Trem = Trlt ( 500 ms ) - Treceive ( 115 ms ) - Tsend ( 110 ms ) - \\ Tcush ( 20 ms ) - Tadflex ( 30 ms ) \\ = 245 ms\end{matrix}$$

Thus, in this particular example, the ad server may determine that it has 245 ms of remaining time to monetize the impression and provide a response to the received ad request. Accordingly, in at least one embodiment, the ad server may be configured or designed to optimize it's servicing of the received ad request by selectively engaging in specifically selected products/activities which the ad server has determined may be successfully completed within the remaining time value (Trem).

For example, based on the remaining available time to service the ad request, and on the dynamically determined timeout values, the ad server may dynamically optimize its servicing of the received ad request by performing one or more of the following activities (or combinations thereof):
Skip the RTB call.
Reduce the RTB timeout parameter to thereby reduce the amount of time spent in waiting for the DSPs to respond to the RTB calls.
Skip calls to Adnet/S2S networks.
Reduce the Adnet/S2S timeout parameter to thereby reduce the amount of time spent in waiting for the Adnet/S2S network(s) to respond to the Adnet/S2S network calls.
Reduce the Call Threshold value to thereby reduce the number of Adnet/S2S network calls/hops to be performed.
Skip the RTB and Adnet/S2S network calls, and only perform calls only to local ad campaign (e.g., Adflex) servers (which take significantly less time to process, as compared to RTB and Adnet/S2S network calls).
Etc.

More generally, the Advertising Service Provider System may be configured or designed to automatically and dynamically determine (e.g., in real-time) the specific monetization efforts that the ad server may perform and complete for any particular impression based on the time available to respond to that impression. In this way, an advertising service provider may throttle the activities performed to try to ensure that an advertising service provider may respond within the available response window.

Additionally, in at least some embodiments, the ad server may be configured or designed to employ dynamic feedback mechanisms and machine learning to decide which activities may be performed and/or skipped for optimal performance.

In the present example scenario, the ad server may dynamically determine (e.g., in real-time) which types of Intelligent Ad Auction activities may be performed based on the dynamically determined remaining time value (Trem) of 245 ms. In some embodiments, in performing this analysis, the ad server may also access and take into account historical time values relating to the average or estimated time for performing one or more types of Intelligent Ad Auction activities.

For example, as illustrated in the example embodiment of FIG. 10, the ad server may perform one or more of the following activities (or combinations thereof):
Determine (1014) whether there is sufficient time remaining for performing a first set of parallel calls to RTB Network(s) and/or Adnet/S2S network(s). For example, in one embodiment, if the ad server determines that Trem≧Trtb, then the ad server may determine that there is sufficient time remaining to solicit RTB bids from RTB Network(s). If the ad server determines that Trem≧Trtb and that Trem≧Tadnet, then the ad server may determine that there is sufficient time remaining to perform, in parallel, the RTB Network calls and a first set of Adnet/S2S network calls. If the ad server determines that Trem≧Trtb and that Trem<Tadnet, then the ad server may determine that there is sufficient time remaining to perform the RTB Network calls, but insufficient time remaining to perform any Adnet/S2S network calls. Alternatively, if the ad server determines that Trem<Trtb and Trem<Tadnet, then the ad server may determine that there is insufficient time remaining to perform either RTB Network calls or Adnet/S2S network calls.
Determine and select a first set of RTB Network(s) and Adnet/S2S network(s) for sending ad solicitation request(s) relating to the first received ad request (e.g., using one or more Intelligent Ad Auction techniques described previously with respect to FIG. 9). For example, in one embodiment, the first set of Adnet/S2S network(s) may by dynamically identified and selected to include any BBC-based Adnet/S2S network(s) whose respective e-CPM bid is greater than (or equal to) the e-CPM bid associated with the highest bidding NBBC-based Adnet/S2S network
Perform (1016) the RTB calls and first set of Adnet/S2S network calls in parallel. In some embodiments, if the ad server determines that there is sufficient time remaining to perform the RTB Network calls, but insufficient time remaining to perform any Adnet/S2S network calls, the ad server may determine to perform the RTB calls and to not perform any Adnet/S2S network calls.
Receive and process received responses to the RTB calls and any responses to the first set of Adnet/S2S network calls (if applicable).
Determine (1018) an updated remaining time (Tup) value. For example, in one embodiment, the Tup value may be calculated according to:

Tup=Trem−(the greater of: (i) actual RTB response time, or (ii) actual Adnet/S2S network response time of first set of Adnet/S2S network calls)
Determine (1020) whether it is desirable to perform additional Adnet/S2S network calls. For example, as described previously, if at least one response is received from either the RTB Network(s) and/or the first set of Adnet/S2S network(s) specifying an e-CPM bid that is higher than the highest bidding NBBC-based Adnet/S2S network, then the impression may be awarded to the highest responding bidder, and no further calls need be made for serving the ad request.
Determine (1022) whether there is sufficient time remaining for performing additional S2S calls. For example, if the ad server determines that Tup≧Tadnet, then the ad server may determine that there is sufficient time remaining to perform, in parallel, a (first or next) set of parallel calls to a (first/next) identified set of Adnet/S2S network(s). Alternatively if the ad server determines that Tup<Tadnet, then the ad server may determine that there is insufficient time remaining to perform any further calls to Adnet/S2S network(s).
Perform (1024) additional set of parallel calls to next selected group of Adnet/S2S Networks. According to different embodiments, this process may repeat with subsequent calls to additional advertiser(s)/Ad Network(s) until one or more specific conditions and/or events is detected such as, for example, one or more of the following (or combinations thereof):
   the specified Call Threshold value has been reached;
   an ad network responds with a non-default response;
   it is determined that there is insufficient time to initiate any additional calls to additional advertiser(s)/Ad Network(s) (e.g., due to response timeout constraints)
Determine (1026) a newly updated remaining time (Tup_new) value. For example, in one embodiment, the Tup_new value may be calculated according to:

Tup_new=Tup−actual Adnet/S2S network response time
(e.g., actual response time associated with the additional set of parallel Adnet/S2S network performed at 1024)
Determine (1028) whether there is sufficient time remaining for performing Ad campaign calls. For example, if the ad server determines that Tup_new>Tadflex, then the ad server may determine that there is sufficient time remaining to perform call(s) to selected Guaranteed Fill Ad Campaign(s).
Perform (1030) call(s) to selected Guaranteed Fill Ad Campaign(s) such as, for example, PubMatic's AdFlex ad campaign(s).
Select (1032) winning ad from responses based on predetermined criteria (e.g., highest e-CPM)
Generate and send (1034) ad request response (e.g., including creative associated with winning ad) to Publisher server.

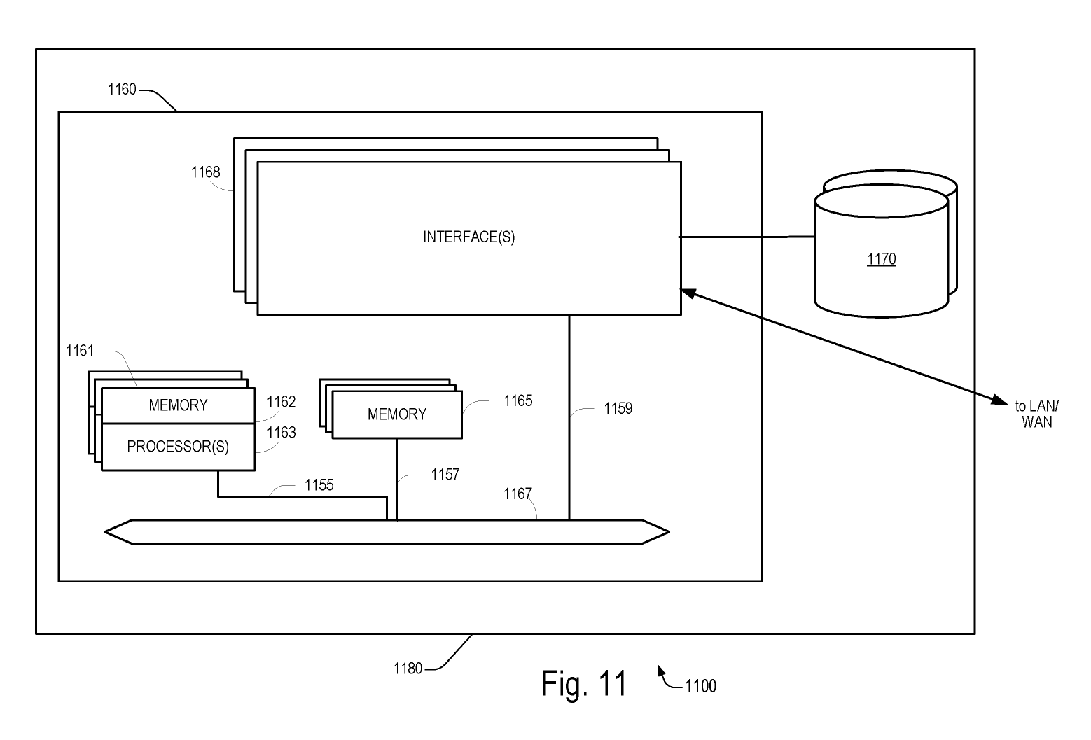

FIG. 11 illustrates an example embodiment of an ad server system 1180 which may be used for implementing various aspects/features described herein, including at least some of the various ad serving and ad auctioning techniques described herein. In at least one embodiment, the ad server system 1180 includes at least one network device 1160, and at least one storage device 1170 (such as, for example, a direct attached storage device, a local data storage device, etc.).

In at least one embodiment, storage device(s) 1170 may be configured or designed to store historical data relating to ad requests and/or impressions which have been processed by the ad server system 1180. In some embodiments, the storage device(s) 1170 may also be configured or designed to store historical data relating to ad requests and/or impressions which have been processed by other ad servers of the Advertising Service Provider System. Other data and information may be stored at one or more of the storage device(s) 1170 including at least a portion of the data, information, parameters and/or criteria disclosed herein. In some embodiments, the storage device(s) 1170 may include appropriate hardware and/or software for implementing database management functionality for defining, creating, querying, updating, and administrating one or more databases.

In according to one embodiment, network device 1160 may include a master central processing unit (CPU) 1162, interfaces 1168, and a bus 1167 (e.g., a PCI bus). When acting under the control of appropriate software or firmware, the CPU 1162 may be responsible for implementing specific functions associated with the functions of a desired network device. For example, when configured as a server, the CPU 1162 may be responsible for analyzing packets; encapsulating packets; forwarding packets to appropriate network devices; instantiating various types of virtual machines, virtual interfaces, virtual storage volumes, virtual appliances; etc. The CPU 1162 preferably accomplishes at least a portion of these functions under the control of software including an operating system (e.g. Linux), and any appropriate system software.

CPU 1162 may include one or more processors 1163 such as, for example, one or more processors from the AMD, Motorola, Intel and/or MIPS families of microprocessors. In an alternative embodiment, processor 1163 may be specially designed hardware for controlling the operations of ad server system 1180. In a specific embodiment, a memory 1161 (such as non-volatile RAM and/or ROM) also forms part of CPU 1162. However, there may be many different ways in which memory could be coupled to the system. Memory block 1161 may be used for a variety of purposes such as, for example, caching and/or storing data, programming instructions, etc.

The interfaces 1168 may be typically provided as interface cards (sometimes referred to as “line cards”). Alternatively, one or more of the interfaces 1168 may be provided as on-board interface controllers built into the system motherboard. Generally, they control the sending and receiving of data packets over the network and sometimes support other peripherals used with the ad server system 1180. Among the interfaces that may be provided may be FC interfaces, Ethernet interfaces, frame relay interfaces, cable interfaces, DSL interfaces, token ring interfaces, Infiniband interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like. Other interfaces may include one or more wireless interfaces such as, for example, 802.11 (WiFi) interfaces, 802.15 interfaces (including Bluetooth™), 802.16 (WiMax) interfaces, 802.22 interfaces, Cellular standards such as CDMA interfaces, CDMA2000 interfaces, WCDMA interfaces, TDMA interfaces, Cellular 3G interfaces, etc.

Generally, one or more interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 1162 to efficiently perform routing computations, network diagnostics, security functions, etc.

In at least one embodiment, some interfaces may be configured or designed to allow the ad server system 1180 to communicate with other network devices associated with various local area network (LANs) and/or wide area networks (WANs). Other interfaces may be configured or designed to allow network device 1160 to communicate with one or more direct attached storage device(s) 1170.

Although the system shown in FIG. 11 illustrates one specific network device described herein, it is by no means the only network device architecture on which one or more embodiments can be implemented. For example, an architecture having a single processor that handles communications as well as routing computations, etc. may be used. Further, other types of interfaces and media could also be used with the network device.

Regardless of network device's configuration, it may employ one or more memories or memory modules (such as, for example, memory block 1165, which, for example, may include random access memory (RAM)) configured to store data, program instructions for the general-purpose network operations and/or other information relating to the functionality of the various ad serving and ad auctioning techniques described herein. The program instructions may control the operation of an operating system and/or one or more applications, for example. The memory or memories may also be configured to store data structures, and/or other specific non-program information described herein.

Because such information and program instructions may be employed to implement the systems/methods described herein, one or more embodiments relates to machine readable media that include program instructions, state information, etc. for performing various operations described herein. Examples of machine-readable storage media include, but are not limited to, magnetic media such as hard disks, floppy disks, and magnetic tape; optical media such as CD-ROM disks; magneto-optical media such as floptical disks; and hardware devices that may be specially configured to store and perform program instructions, such as read-only memory devices (ROM) and random access memory (RAM). Examples of program instructions include both machine code, such as produced by a compiler, and files containing higher level code that may be executed by the computer using an interpreter.

Additional details relating to various aspects of online advertising technology are disclosed in the following references:

U.S. patent application Ser. No. 12/510,061, by Goel et al., titled “DYNAMIC SELECTION OF OPTIMAL ADVERTISING NETWORK”, filed Jul. 27, 2009, the entirety of which is incorporated herein by reference for all purposes.

U.S. patent application Ser. No. 13/708,435, by KUMAR et al., titled “GRANULAR CONTROL APPLICATION FOR DELIVERING ONLINE ADVERTISING”, filed Dec. 7, 2012, the entirety of which is incorporated herein by reference for all purposes.

Although several example embodiments of one or more aspects and/or features have been described in detail herein with reference to the accompanying drawings, it is to be understood that aspects and/or features are not limited to these precise embodiments, and that various changes and modifications may be effected therein by one skilled in the art without departing from the scope of spirit of the invention(s) as defined, for example, in the appended claims.

It is claimed:

1. A method of causing the at least one processor to execute instructions for:
identifying at least one action to be implemented at an ad server to facilitate the ad server in monetizing a first ad impression and in enabling the ad server to provide a response to the first ad request which is received at the remote device within an amount of time that does not exceed a Response Latency Timeout value;
initiating, at the ad server, the identified at least one action; and
wherein the identified at least one action includes at least one action selected from a group consisting of:
(a) omitting performance of a real-time bid (RTB) auction in connection with the first ad request;
(b) reducing a timeout parameter associated with RTB ad solicitation request calls to thereby reduce an amount of time spent in waiting for responses to the RTB ad solicitation request calls to be received at the ad server during servicing of the first ad request;
(c) omitting performance of one or more ad solicitation request calls to one or more mobile advertising networks during servicing of the first ad request;
(d) reducing a timeout parameter associated with mobile advertising network ad solicitation request calls to thereby reduce an amount of time spent in waiting for responses to the mobile advertising network ad solicitation request calls to be received at the ad server during servicing of the first ad request; and
(e) reducing a Call Threshold value to thereby reduce a number of mobile advertising network ad solicitation request calls or hops to be performed by the ad server in servicing the first ad request.

2. The method of claim 1 further comprising causing the at least one processor to execute instructions for:
dynamically determining a remaining time value (Trem) representing a maximum total amount of remaining time available for the ad server to service the first ad request, wherein a calculation of the Trem value includes subtracting from the Trlt value the Treceive value and the Tsend value; and
selectively identifying, using the Trem value, the first set of activities to be performed by the ad server to monetize the first ad impression.

3. The method of claim 1 further comprising causing the at least one processor to execute instructions for:
determining if there is sufficient time available for the ad server to solicit real-time bid (RTB) response(s) from a first set of advertising network(s) in connection with the first ad request and to provide a response to the first ad request which is received at the remote device within an amount of time that does not exceed the Response Latency Timeout value;
if it is determined that there is sufficient time available for the ad server to solicit real-time bid (RTB) response(s) from the first set of advertising network(s) in connection with the first ad request, performing the real-time bid (RTB) auction in connection with servicing the first ad request; and
if it is determined that there is insufficient time available for the ad server to solicit real-time bid (RTB) response(s) from the first set of advertising network(s) in connection with the first ad request, omitting performance of the real-time bid (RTB) auction in connection with servicing ad request.

4. A computer implemented method for facilitating servicing of ad requests over an electronic data network, the method comprising causing at least one processor to execute a plurality of instructions for:
receiving, at a first ad server, a first ad request from a remote device, the first ad request including information relating to a first ad impression to be displayed in connection with a display of a first web page at an end user's device, the first web page being associated with a first publisher;
concurrently sending selected ad solicitation request to multiple different ad networks in parallel to reduce latency in which a set of activities is selected based on a determination of an amount of time that the ad sever has to respond to the first ad request, including:
determining a first Response Latency Timeout value (Trlt) to be used for servicing the first ad request, wherein the first Response Latency Timeout value represents a total maximum amount of time which is permitted to elapse until a response to the first ad request is received at the remote device;
dynamically determining a Treceive value representing a first amount of time taken for the first ad request from the remote device to reach the ad server;
determining a Tsend value representing a second amount of time it takes for an ad request response from the ad server to reach the remote device;
dynamically determining, in real-time, an amount of remaining time which is currently available for the ad server to monetize the first ad impression and provide a response to the first ad request which is received at the remote device within an amount of time that does not exceed the Response Latency Timeout value;
selectively identifying a first set of activities to be performed by the ad server to monetize the first ad impression in the amount of time remaining and provide the response to the first ad request which is received at the remote device within the amount of time that does not exceed the Response Latency Timeout value;
performing the identified first set of activities at the ad server for monetizing the first ad impression;
providing the response to the first ad request to the remote device such that the response is received at the remote device within the amount of time that does not exceed the Response Latency Timeout value;
dynamically determining a remaining time value (Trem) representing a maximum total amount of remaining time available for the ad server to service the first ad request, wherein a calculation of the Trem value includes subtracting from the Trlt value the Treceive value and the Tsend value; and
making a determination whether there is sufficient time to perform a second set of activities in parallel in the remaining time value.

5. A computer implemented method for facilitating servicing of ad requests over an electronic data network, the method comprising causing at least one processor to execute a plurality of instructions for:
receiving, at a first ad server, a first ad request from a remote device, the first ad request including information relating to a first ad impression to be displayed in connection with a display of a first web page at an end user's device, the first web page being associated with a first publisher;
concurrently sending selected ad solicitation requests consecutively to multiple different ad networks in parallel to reduce latency in which a set of activities is dynamically selected based on a determination of an amount of time that the ad sever has to respond to the first ad request and whether at least one additional hop is to be performed, including:
determining a first Response Latency Timeout value (Trlt) to be used for servicing the first ad request, wherein the first Response Latency Timeout value represents a total maximum amount of time which is permitted to elapse until a response to the first ad request is received at the remote device;
dynamically determining a Treceive value representing a first amount of time taken for the first ad request from the remote device to reach the ad server;
determining a Tsend value representing a second amount of time it takes for an ad request response from the ad server to reach the remote device;
dynamically determining, in real-time, an amount of remaining time which is currently available for the ad server to monetize the first ad impression and provide a response to the first ad request which is received at the remote device within an amount of time that does not exceed the Response Latency Timeout value;
selectively identifying a first set of activities to be performed by the ad server to monetize the first ad impression in the amount of time remaining and provide the response to the first ad request which is received at the remote device within the amount of time that does not exceed the Response Latency Timeout value;
performing the identified first set of activities at the ad server for monetizing the first ad impression;
providing the response to the first ad request to the remote device such that the response is received at the remote device within the amount of time that does not exceed the Response Latency Timeout value;
soliciting real-time bid (RTB) response(s) from a first set of advertising network(s) in connection with the first ad request;
thereafter, dynamically determining, in real-time, an updated remaining time value (Tup) representing an amount of remaining time which is currently available for the ad server to service the first ad request and provide a response to the first ad request which is received at the remote device within an amount of time that does not exceed the Response Latency Timeout value;
dynamically determining, using the Tup time value, if there is sufficient time available for the ad server to perform a hop of mobile advertising network call(s) to a first set of mobile network advertisers in connection with the first ad request and provide a response to the first ad request which is received at the remote device within an amount of time that does not exceed the Response Latency Timeout value;
if it is determined that there is sufficient time available for the ad server to perform the first hop of mobile advertising network call(s), performing the first hop of mobile advertising network call(s) to the first set of mobile network advertisers in connection with servicing the first ad request; and
if it is determined that there is insufficient time available for the ad server to perform the first hop of mobile advertising network call(s) in connection with the first ad request, omitting performance of the first hop of mobile advertising network call(s) in connection with servicing ad request.

6. The method of claim 5 further comprising causing the at least one processor to execute instructions for:
performing a first hop of mobile advertising network call(s) to a first set of mobile network advertisers in connection with the first ad request;
thereafter, dynamically determining, in real-time, an updated remaining time value (Tup) representing an amount of remaining time which is currently available for the ad server to service the first ad request and provide a response to the first ad request which is received at the remote device within an amount of time that does not exceed the Response Latency Timeout value;
dynamically determining, using the Tup time value, if there is sufficient time available for the ad server to perform a second hop of mobile advertising network call(s) to a second set of mobile network advertisers in connection with the first ad request and provide a response to the first ad request which is received at the remote device within an amount of time that does not exceed the Response Latency Timeout value;
if it is determined, using the Tup time value, that there is sufficient time available for the ad server to perform the second hop of mobile advertising network call(s), performing the second hop of mobile advertising network call(s) to the second set of mobile network advertisers in connection with servicing the first ad request; and
if it is determined, using the Tup time value, that there is insufficient time available for the ad server to perform the second hop of mobile advertising network call(s) in connection with the first ad request, omitting performance of the second hop of mobile advertising network call(s) in connection with servicing ad request.

7. A method for facilitating servicing of ad requests over an electronic data network, the system comprising:
receiving, at a first ad server, a first ad request from a remote device, the first ad request including information relating to a first ad impression to be displayed in connection with a display of a first web page at an end user's device, the first web page being associated with a first publisher;
determining a first Response Latency Timeout value (Trlt) to be used for servicing the first ad request, wherein the first Response Latency Timeout value represents a total maximum amount of time which is permitted to elapse until a response to the first ad request is received at the remote device;
dynamically determining a Treceive value representing a first amount of time taken for the first ad request from the remote device to reach the ad server;
determining a Tsend value representing a second amount of time it takes for an ad request response from the ad server to reach the remote device;
dynamically determining, in real-time, an amount of remaining time which is currently available for the ad server to monetize the first ad impression and provide a response to the first ad request which is received at the remote device within an amount of time that does not exceed the Response Latency Timeout value;
selectively identifying a first set of activities to be performed by the ad server to monetize the first ad impression in the amount of time remaining and provide the response to the first ad request which is received at the remote device within the amount of time that does not exceed the Response Latency Timeout value;
performing the identified first set of activities at the ad server for monetizing the first ad impression;
identifying at least one action to be implemented at the ad server to facilitate the ad server in monetizing the first ad impression and in enabling the ad server to provide the response to the first ad request which is received at the remote device within an amount of time that does not exceed the Response Latency Timeout value;
initiating, at the ad server, the identified at least one action including reducing a Call Threshold value to thereby reduce a number of mobile advertising network ad solicitation request calls or hops to be performed by the ad server in servicing the first ad request.
